(19) United States
(12) Patent Application Publication
(10) Pub. No.: US 2026/0072504 A1
(43) Pub. Date: Mar. 12, 2026

(54) MULTIMODAL FUSION DETECTION APPARATUS AND METHOD BASED ON OPTICAL PUMPING AND PHOTOACOUSTIC IMAGING

(71) Applicant: Westlake University, Hangzhou (CN)

(72) Inventors: Chengpeng Chai, Hangzhou (CN); Junjian Tang, Hangzhou (CN); Yun-Hsuan Chen, Hangzhou (CN); Fuzhi Cao, Hangzhou (CN); Xi Yang, Hangzhou (CN); Fulong Wang, Hangzhou (CN); Xurong Gao, Hangzhou (CN); Kaiyu Wang, Hangzhou (CN); Xun Zhang, Hangzhou (CN); Mohamad Sawan, Hangzhou (CN)

(73) Assignee: Westlake University, Hangzhou (CN)

(21) Appl. No.: 19/340,774

(22) Filed: Sep. 25, 2025

Related U.S. Application Data
(63) Continuation-in-part of application No. 19/181,354, filed on Apr. 17, 2025, now Pat. No. 12,471,778.

(30) Foreign Application Priority Data
Sep. 6, 2024 (CN) 202411249231.6
Jun. 28, 2025 (CN) 202510883343.5

(51) Int. Cl. G06F 3/01; G06V 10/80

(52) U.S. Cl. CPC G06F 3/015; G06V 10/811; G06V 2201/034

(57) ABSTRACT

A multimodal fusion detection apparatus and method based on optical pumping and photoacoustic imaging are provided, relating to the field of fusion detection technology. In the apparatus, the atomic vapor cell detection path and the first laser irradiation path are both directed toward a target region and at least partially overlap. In this way, the detection paths of optical pumping and photoacoustic imaging are at least partially coincident, ensuring that electrophysiological signals and blood oxygen signals originate from the same tissue region and avoiding the spacing constraints of conventional sensors. Thus, the detection path of the atomic vapor cell can be used for both magnetic field detection and photoacoustic detection, enabling simultaneous acquisition of magnetic and photoacoustic signals at a single detection point, achieving hardware reuse for multimodal fusion detection at the same location and time, reducing device size, and minimizing crosstalk among multimodal sensors.

### CROSS-REFERENCE TO RELATED APPLICATIONS

This application is a continuation-in-part of U.S. patent application Ser. No. 19/181,354, filed on Apr. 17, 2025, and claims priority to Chinese Patent Application No. 202510883343.5, filed on Jun. 28, 2025. the entire patent application of which are incorporated herein by reference.

### TECHNICAL FIELD

The present application relates to the technical field of fusion detection, and more particularly to a multimodal fusion detection apparatus and method based on optical pumping and photoacoustic imaging.

### BACKGROUND

At present, non-invasive brain-computer interfaces can be classified into two categories according to the type of detected biological signals: electromagnetic physiological signal-dependent sensors and blood oxygen-dependent sensors. The electromagnetic physiological signal-dependent sensors include, for example, EEG (Electroencephalogram) sensors and OPM (Optically-Pumped Magnetometer) sensors. The blood oxygen-dependent sensors include, for example, fNIRS (functional near-infrared spectroscopy) sensors and PAI (Photoacoustic Imaging) sensors.

EEG sensors and OPM sensors detect electric fields or magnetic fields generated by physiological activities of the human body (including cardiomagnetic and neuromagnetic activities), thereby assisting in analyzing instant variations when the human body responds to different scenarios or requirements. The fNIRS sensors and PAI sensors utilize laser stimulation of tissues and provide structural and functional information of blood oxygen and tissues by detecting changes in blood oxygen or photoacoustic signals generated by photothermal effects.

The electromagnetic physiological signal-dependent sensors exhibit high temporal resolution but low spatial resolution, whereas the blood oxygen-dependent sensors exhibit low temporal resolution but high spatial resolution. Therefore, current multimodal brain-computer interfaces generally adopt a technical solution of multimodal fusion of electromagnetic physiological signals and blood oxygen physiological signals, so as to provide rapid dynamic information as well as accurate blood oxygen and spatial localization information.

However, in the prior art, EEG sensors, fNIRS sensors, OPM sensors, and PAI sensors are all independent devices, which leads to the following problems:
1.Problem of positional co-localization.

Whether in conventional multimodal systems combining EEG and fNIRS, or in emerging multimodal systems combining OPM and PAI, due to fundamental differences in their physical structures and functional principles, it is difficult for these devices to share the same measurement points in a single setup:
a) Example 1: In conventional multimodal systems, bulky fNIRS fibers and EEG cables and electrodes compete for limited head space, making it mechanically challenging to couple EEG electrodes and fNIRS sources and detectors onto the subject's head (with distances greater than 1 cm).
b) Example 2: In emerging multimodal systems combining EEG and OPM, customized EEG sensors made of Ag/AgCl powder-sintered cylindrical silver-plated copper wires are required to ensure that residual magnetic fields are less than 50 pT and distances are greater than 2 cm, so as not to cause power spectral density variations in OPM.
c) Example 3: In emerging multimodal systems combining EEG and PAI, it is necessary to ensure that frequency multiplexing of high-channel-count light source systems does not cause electrical crosstalk to EEG within 1 cm.
2. Problem of temporal synchronization.

Independent EEG, fNIRS, OPM, and PAI sensors generally require timestamp alignment, a central synchronization control system, or shared hardware components in order to achieve synchronization across multimodal timelines. Timestamp alignment ensures that data collected from different devices can be precisely matched on the same time axis, while a central synchronization control system provides a unified trigger mechanism to simultaneously start all measurement devices, thereby ensuring data acquisition synchronization. Hardware sharing may include, for example, ADC multiplexing or reuse of light sources. However, these methods are limited by RF wiring structures and are still insufficient to meet the requirements of full-channel, long-term measurement synchronization.

Although both OPM and fNIRS utilize light sources, fNIRS cannot share its light source with OPM because fNIRS light sources must be activated according to precise timing sequences to avoid interference between different light sources. Moreover, such time-division multiplexing requires strict control over the activation and deactivation timing of each light source. Since fNIRS relies on detecting the scattering and absorption of light in brain tissue, it is highly sensitive to the timing of light source activation. Improper management may result in data capture errors and compromise the accuracy of experimental results.

In summary, traditional brain-computer interfaces encounter issues in multimodal fusion of electromagnetic physiological signals and blood oxygen signals, including asynchronous measurements in time, inconsistent positional localization, bulky device size, and crosstalk with certain new types of multimodal sensors.

### SUMMARY

In view of the foregoing, an object of the present application is to provide a multimodal fusion detection apparatus and method based on optical pumping and photoacoustic imaging, which can realize multimodal fusion detection at the same position and at the same time through hardware reuse, while reducing the device size and minimizing crosstalk among multimodal sensors.

To achieve the above object, an embodiment of the present application adopts the following technical solution:

According to a first aspect, the present application provides a multimodal fusion detection apparatus based on optical pumping and photoacoustic imaging, comprising: a laser generator; an atomic vapor cell optically coupled between the laser generator and a target region, the atomic vapor cell having a detection path configured to be directed toward the target region; a detection unit comprising a photoacoustic detector, a photodetector, and a processor, the processor being electrically connected to both the photoacoustic detector and the photodetector, wherein the laser generator is configured to generate a first laser in pulsed form, an irradiation path of the first laser being directed toward the target region, the irradiation path of the first laser at least partially overlapping with the detection path of the atomic vapor cell; the laser generator is further configured to generate a second laser, an irradiation path of the second laser propagating through the atomic vapor cell and being directed toward the photodetector, the wavelength of the second laser being different from an atomic excitation wavelength of the atomic vapor cell; the photoacoustic detector is configured to, when a measured part of a subject is associated with the target region, acquire photoacoustic signal data corresponding to an interaction between the first laser and the measured part; the photodetector is configured to acquire laser variation data corresponding to the second laser after propagating through the atomic vapor cell; and the processor is configured to determine physiological signals of the subject based on the laser variation data and the photoacoustic signal data.

It should be understood that the apparatus provided in the first aspect of the present application has the following advantageous effects:

The detection path of the atomic vapor cell is directed toward the target region, the irradiation path of the first laser is directed toward the target region, and the irradiation path of the first laser at least partially overlaps with the detection path of the atomic vapor cell. In this way, the detection paths of optical pumping (OPM) and photoacoustic imaging (PAI) at least partially overlap, ensuring that both electrophysiological signals and blood oxygen signals originate from the same tissue region, thereby avoiding the sensor spacing requirements in conventional technologies. That is, the detection path of the atomic vapor cell can be used not only for magnetic field detection but also for photoacoustic detection, thereby enabling simultaneous acquisition of magnetic field signals and photoacoustic signals at a single detection point. Accordingly, hardware reuse can be realized to achieve multimodal fusion detection at the same position and at the same time, while reducing the device size and minimizing crosstalk among multimodal sensors.

According to a second aspect, the present application provides a multimodal fusion detection apparatus based on optical pumping and photoacoustic imaging, wherein the apparatus is configured to operate in a magnetic shielding environment, the apparatus comprising: a laser generator; an atomic vapor cell optically coupled between the laser generator and a target region, the atomic vapor cell having a detection path configured to be directed toward the target region; a detection unit comprising a photoacoustic detector, a photodetector, and a processor, the processor being electrically connected to both the photoacoustic detector and the photodetector, wherein the laser generator is configured to generate a first laser, the first laser being a continuous-wave (CW) laser or a quasi-continuous-wave (QCW) laser, an irradiation path of the first laser propagating through the atomic vapor cell and being directed toward the target region, the first laser being used to excite atoms in the atomic vapor cell into an excited state; the laser generator is further configured to generate a second laser, an irradiation path of the second laser propagating through the atomic vapor cell and being directed toward the photodetector, the wavelength of the second laser being different from an atomic excitation wavelength of the atomic vapor cell; the photoacoustic detector is configured to, when a measured part of a subject is associated with the target region, acquire photoacoustic signal data corresponding to an interaction between the first laser and the measured part; the photodetector is configured to acquire laser variation data corresponding to the second laser after propagating through the atomic vapor cell, and the processor is configured to determine physiological signals of the subject based on the laser variation data and the photoacoustic signal data.

It should be understood that the apparatus provided in the second aspect of the present application has the following advantageous effects:

An irradiation path of the first laser is configured to propagate through the atomic vapor cell and then be directed toward the target region. When a measured part of a subject is associated with the target region, the detector can perform photoacoustic (PA) detection based on the photoacoustic signal data corresponding to an interaction between the first laser and the measured part, thereby functioning as a photoacoustic sensor. The first laser is further configured to be a continuous-wave laser or a quasi-continuous-wave laser and to excite atoms in the atomic vapor cell into an excited state. The wavelength of the second laser is configured to be different from an atomic excitation wavelength of the atomic vapor cell. By acquiring laser variation data corresponding to the second laser after propagating through the atomic vapor cell, magnetic field detection can be achieved based on the detected data, thereby functioning as an optically-pumped magnetometer (OPM). Since the irradiation path of the first laser is configured to propagate through the atomic vapor cell and then be directed toward the target region, and the detection path of the atomic vapor cell is configured to be directed toward the target region, the detection path of the atomic vapor cell can be used both for magnetic field detection and for photoacoustic detection. Accordingly, simultaneous acquisition of magnetic field signals and photoacoustic signals at a single detection point can be achieved, enabling hardware reuse to realize multimodal fusion detection at the same position (without physical competition of devices), with inherent temporal synchronization (without timestamps or inter-device communication), high spatio-temporal resolution, and non-invasiveness. Meanwhile, the apparatus size can be reduced, crosstalk among multimodal sensors can be minimized, and coupling studies of neural activity and hemodynamic status can be implemented.

According to a third aspect, the present application provides a multimodal fusion detection method based on optical pumping and photoacoustic imaging, applied to a multimodal fusion detection apparatus; the apparatus comprises a laser generator, an atomic vapor cell, and a detection unit; the atomic vapor cell is optically coupled between the laser generator and a target region, the atomic vapor cell having a detection path configured to be directed toward the target region; the detection unit comprises a photoacoustic detector, a photodetector, and a processor, the processor being electrically connected to both the photoacoustic detector and the photodetector; the method comprising:
generating, by the laser generator, a first laser in pulsed form, an irradiation path of the first laser being directed toward the target region, the irradiation path of the first laser at least partially overlapping with the detection path of the atomic vapor cell;
generating, by the laser generator, a second laser, an irradiation path of the second laser propagating through the atomic vapor cell and being directed toward the photodetector, the wavelength of the second laser being different from an atomic excitation wavelength of the atomic vapor cell;
acquiring, by the photoacoustic detector, photoacoustic signal data corresponding to an interaction between the first laser and a measured part of a subject when the measured part is associated with the target region;
acquiring, by the photodetector, laser variation data corresponding to the second laser after propagating through the atomic vapor cell; and
determining, by the processor, physiological signals of the subject based on the laser variation data and the photoacoustic signal data.

To make the foregoing objects, features, and advantages of the present application more readily understood, exemplary embodiments of the application will be described in detail below with reference to the accompanying drawings.

### BRIEF DESCRIPTION OF THE DRAWINGS

To more clearly illustrate the technical solutions of the embodiments of the present application, the drawings required to describe the embodiments are briefly introduced below. It is to be understood that the following drawings illustrate only certain embodiments of the present application and therefore should not be construed as limiting the scope. For those skilled in the art, other related drawings may be derived from these figures without inventive efforts.

FIG. 1 is a schematic structural diagram of a multimodal fusion detection apparatus based on optical pumping and photoacoustic imaging according to an embodiment of the present application;

FIG. 2 is another schematic structural diagram of a multimodal fusion detection apparatus based on optical pumping and photoacoustic imaging according to an embodiment of the present application;

FIG. 3 is still another schematic structural diagram of a multimodal fusion detection apparatus based on optical pumping and photoacoustic imaging according to an embodiment of the present application;

FIG. 4 is a schematic diagram of an output pulse cycle of a first laser according to an embodiment of the present application;

FIG. 5 is a schematic diagram of a photoacoustic pressure signal conducted by a photoacoustic signal corresponding to an interaction between the first laser and a measured part of a subject according to an embodiment of the present application;

FIG. 6 is another schematic diagram of a photoacoustic pressure signal conducted by a photoacoustic signal corresponding to an interaction between the first laser and a measured part of a subject according to an embodiment of the present application;

FIG. 7 is still another schematic diagram of a photoacoustic pressure signal conducted by a photoacoustic signal corresponding to an interaction between the first laser and a measured part of a subject according to an embodiment of the present application;

FIG. 8 is yet another schematic structural diagram of a multimodal fusion detection apparatus based on optical pumping and photoacoustic imaging according to an embodiment of the present application;

FIG. 9 is a flowchart of a multimodal fusion detection method based on optical pumping and photoacoustic imaging according to an embodiment of the present application;

FIG. 10 is another flowchart of a multimodal fusion detection method based on optical pumping and photoacoustic imaging according to an embodiment of the present application.

### REFERENCE NUMERALS

100: Multimodal fusion detection apparatus based on optical pumping and photoacoustic imaging; 110: Laser generator; 111: First laser emission port; 112: Second laser emission port; 120: Atomic vapor cell; 121: Second laser entry port; 122: Detection port; 123: Second laser exit port; 130: Detection unit; 131: Photoacoustic detector; 131-1: Detection point; 132: Photodetector; 132-1: Laser receiving port; 133: Processor; 140: Target region; 150: Laser path controller; 151: Path control incident port; 152: Path control emission port.
200: Multimodal fusion detection apparatus based on optical pumping and photoacoustic imaging; 210: Pulsed laser device; 211: Optical filter; 212: Focusing lens; 213: Beam aperture; 214: Focusing lens; 215, 216: Beam splitter; 220: Refractive lens; 221: Collimating lens; 230: Atomic vapor cell; 240: Balanced photodetector; 241: Beam splitter; 242: Photodetection port; 243: Photodetection port; 250: Signal amplifier; 251: Ultrasonic transducer; 253: Reference photodetection port; 260: Data acquisition device; 270: Fiber coupler; 271: Optical amplifier; 272: Diffuser.
300: Multimodal fusion detection apparatus based on optical pumping and photoacoustic imaging; 310: Laser generator; 311: First laser emission port; 312: Second laser emission port; 320: Atomic vapor cell; 321: Laser entry port; 322: Detection port; 323: laser exit port; 330: Detection unit; 331: Photoacoustic detector; 331-1: Detection point; 332: Photodetector; 332-1: Laser receiving port; 333: Processor; 340: Target region.
800: Multimodal fusion detection apparatus based on optical pumping and photoacoustic imaging; 810: First laser device; 811: Optical filter; 812: Focusing lens; 813: Beam aperture; 814: Focusing lens; 815: Second laser device; 816: Optical filter; 817: Focusing lens; 818: Beam aperture; 819: Focusing lens; 820: Refractive lens; 830: Atomic vapor cell; 840: Balanced photodetector; 841: Beam splitter; 842: Photodetection port; 843: Photodetection port; 850: Signal amplifier; 851: Ultrasonic transducer; 853: Beam splitter; 854: Reference photodetection port; 860: Data acquisition device; 870: Fiber coupler; 871: Optical amplifier; 872: Diffuser.

### DETAILED DESCRIPTION

To clarify the objectives, technical solutions, and advantages of the embodiments of the present application, the following description combines the drawings to provide a clear and comprehensive explanation of the technical solutions in the embodiments. Evidently, the described embodiments represent only a portion of the application's implementations rather than exhaustive examples. Components illustrated in the drawings may be arranged and designed through various configurations.

Therefore, the detailed description of the embodiments provided in the drawings is not intended to limit the claimed scope of the application but merely illustrates selected implementations. All other embodiments obtained by those skilled in the art based on the disclosed embodiments without inventive efforts shall fall within the protection scope of the present application.

It should be noted that identical reference numerals denote similar elements across the drawings. Once an element is defined in one figure, it requires no further definition or explanation in subsequent figures.

Additionally, it should be noted that features in the embodiments of the present application may be combined reciprocally provided such combinations are implemented in a non-conflicting manner.

During the implementation of the embodiments of this application, the inventors identified critical challenges in prior art systems. While EEG, fNIRS, and PAI have seen extensive development, integrating multiple discrete detectors introduces significant limitations:
1. Spatial Synchronization Challenges:

In multimodal BCI applications, conventional devices like EEG and fNIRS employ wearable soft caps for data acquisition. However, inherent differences in their physical architecture and operational principles prevent sensor or measurement point sharing within a unified setup. Bulky fNIRS optical fibers, EEG cables, and electrodes compete for scalp coverage, creating mechanical integration challenges when coupling EEG electrodes with fNIRS sources/detectors on a subject's head.
2. Temporal Synchronization Challenges

Achieving sufficient temporal precision and simultaneous fNIRS-EEG recording synchronization remains problematic. Current solutions for temporal alignment include time-stamp synchronization, centralized synchronization control systems and partial hardware reuse. While timestamp alignment ensures temporal matching of multi-device data, and centralized systems trigger simultaneous measurements via unified mechanisms, hardware sharing can include ADC and light source reuse, these approaches still fail to meet stringent synchronization requirements.
3. Crosstalk Challenges Between Devices

Custom EEG sensors using Ag/AgCl powder-sintered cylindrical silver-coated copper wires are required to limit residual magnetic fields below 50 pT, preventing OPM power spectral density fluctuations. Additionally, frequency multiplexing in high-channel-count light source systems must avoid electrical crosstalk with EEG. Nevertheless, existing methods still lead to unacceptable crosstalk between multimodal sensors.

In view of some or all of the above problems, embodiments of the present application provide a multimodal fusion detection apparatus and method based on optical pumping and photoacoustic imaging. The apparatus and method relate to technical fields including brain-computer interfaces, quantum mechanics, neuroscience, optics, acoustics, and fusion detection, and can be applied to realize non-invasive wearable brain-computer interface (BCI) sensors. Through hardware reuse, multimodal fusion detection at the same position (without physical competition of devices), with inherent temporal synchronization (without timestamps or inter-device communication), without magnetic shielding, with high spatio-temporal resolution, and in a non-invasive manner can be achieved. At the same time, the apparatus size can be reduced, crosstalk among multimodal sensors can be minimized, and coupling studies of neural activity (including neuromagnetic and cardiomagnetic activities) and hemodynamic status can be implemented.

The technical solutions provided by the present application will be described below with reference to the accompanying drawings.

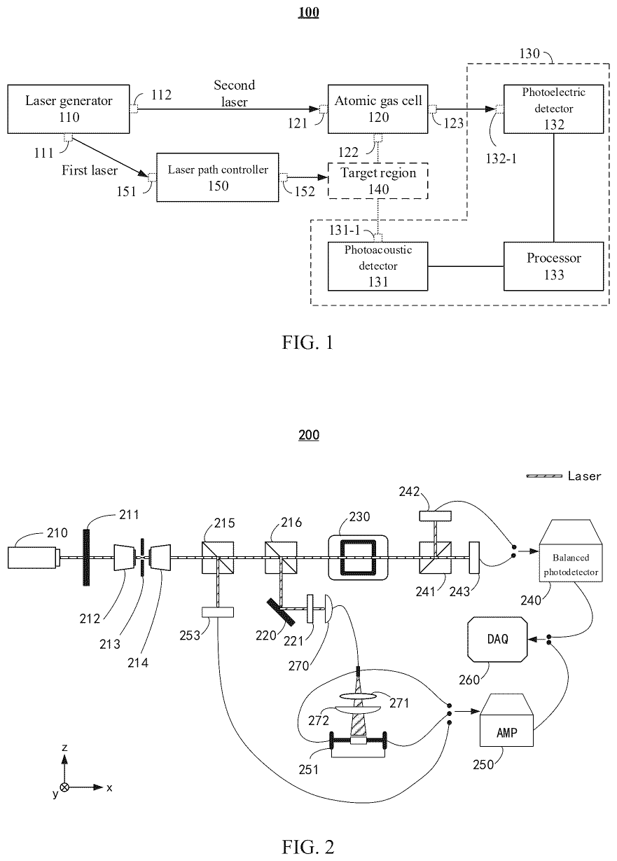

First, an embodiment of the present application provides a multimodal fusion detection apparatus based on optical pumping and photoacoustic imaging. Referring to FIG. 1, FIG. 1 is a schematic structural diagram of a multimodal fusion detection apparatus based on optical pumping and photoacoustic imaging according to an embodiment of the present application. The apparatus 100 may comprise: a laser generator 110, an atomic vapor cell 120, and a detection unit 130. The detection unit 130 may comprise: a photoacoustic detector 131, a photodetector 132, and a processor 133.

The laser generator 110 is configured to generate a laser.

Optionally, the apparatus shown in FIG. 1 may further comprise a laser path controller 150, which is configured to control the propagation path of the laser to realize laser path control. The laser path controller may comprise optical components such as refractive lenses that can be used to control the propagation path of the laser.

The atomic vapor cell 120 may be a vapor cell based on the principle of an optically-pumped magnetometer. For example, the atomic vapor cell 120 may be an empty cell containing 87Rb atoms or 4He. Depending on practical applications and implementation requirements, the atomic vapor cell 120 may further comprise a heating module (electric heating circuit), a modulation magnetic field generation module (modulation magnetic field generation circuit), and the like, without being limited thereto.

Depending on practical applications and implementation requirements, the laser generator 110 may further comprise optical components such as an optical filter and/or a polarizer, which can be used to control the propagation path of the laser.

The photodetector 132 may be configured to convert an optical signal into an electrical signal for detecting variations in laser intensity. The photodetector 132 may also cooperate with the atomic vapor cell 120 and the processor 133 to perform physiological signal detection based on an optically-pumped magnetometer according to pulsed lasers generated by the laser generator 110.

The photoacoustic detector 131 may be configured to detect photoacoustic wave signals, and may cooperate with the processor 133 to perform blood oxygen signal detection based on photoacoustic imaging according to pulsed lasers generated by the laser generator 110.

The processor 133 may be configured to process input data according to a preset algorithm program so as to achieve corresponding algorithm objectives and output data calculated based on the algorithm. For example, the processor 133 in the present application may include, but is not limited to, computer devices comprising CPU processing chip circuits and memory chip circuits (e.g., notebook computers, desktop computers, servers, and the like). In other words, the processor 133 may be implemented using, for example, commercial microprocessors, FPGAs, microcontrollers, or a combination of hardware and software, for executing predefined algorithms and processing input data.

The laser generator 110 comprises a first laser emission port 111 and a second laser emission port 112. The laser path controller 150 comprises a path control incident port 151 and a path control emission port 152. The atomic vapor cell 120 comprises a second laser entry port 121, a second laser exit port 123, and a detection port 122. The photodetector 132 comprises a laser receiving port 132-1. The photoacoustic detector 131 comprises a detection point 131-1. The photodetector 132 and the photoacoustic detector 131 are electrically connected to the processor 133, respectively.

The detection port of the atomic vapor cell may refer to a physical window of the atomic vapor cell, the physical window being disposed on a detection path and configured to be directed toward a known spatial position of a subject to be measured.

In FIG. 1, the second laser emission port 112 is aligned with the second laser entry port 121, the first laser emission port 111 is aligned with the path control incident port 151, the path control emission port 152 is aligned with the target region 140, and the detection port 122 is aligned with the target region 140. The laser receiving port 132-1 is optically aligned with the second laser exit port 123, and the detection point 131-1 is associated with the target region 140.

For the embodiments, the following explanations are provided:
1. For the embodiments, the term “optically aligned” may be understood as direct alignment between A and B, or indirect alignment between A and B through certain media. For example, the alignment described herein may be interpreted as follows: a laser beam emitted from point A is directly aligned with point B in a straight line; or a laser beam emitted from point A is redirected by certain optical components before being aligned with point B.
2. For the embodiments, the optical alignment relationships shown in FIG. 1 are merely examples and are not intended to limit the alignment between the respective modules, units, or components. Specifically, the alignment between one laser emission/entry/exit port and another laser emission/entry/exit port may be either direct alignment or indirect alignment.
3. For the embodiments, the association between the detection point 131-1 and the target region 140 may be understood such that the detection point 131-1 is disposed near, around, or within the target region 140, without limitation. The association between the detection point 131-1 and the target region 140 enables the photoacoustic detector 131 to perform detection of the target region 140.

In some optional embodiments, in the laser path controller 150, the laser enters from the path control incident port 151 and exits from the path control emission port 152. In the atomic vapor cell 120, the laser enters from the second laser entry port 121 and exits from the second laser exit port 123.

In other words, the laser generator 110 may generate a second laser and a first laser.

The propagation path of the second laser, arranged in sequential order, may comprise: the second laser emission port 112→the second laser entry port 121→the atomic vapor cell 120→the second laser exit port 123→the laser receiving port 132-1.

The propagation path of the first laser, arranged in sequential order, may comprise: the first laser emission port 111→the path control incident port 151→the laser path controller 150→the path control emission port 152→the target region 140.

For the apparatus shown in FIG. 1, in some embodiments, the laser generator 110 may be configured to generate a second laser and a first laser. The laser path controller 150 may be configured to direct the irradiation path of the first laser toward the target region 140, and optionally, to configure the irradiation path of the second laser to propagate through the atomic vapor cell 120. The atomic vapor cell 120 may be arranged to be associated with the target region 140, that is, the atomic vapor cell 120 is arranged for detecting the target region.

Furthermore, the photodetector 132, the photoacoustic detector 131, and the processor 133 may together constitute a detection unit 130. When a measured part of a subject is associated with the target region 140, the detection unit 130 may be used to acquire laser intensity and polarization variation signals corresponding to the second laser after propagating through the atomic vapor cell 120, as well as an ultrasonic signal (also referred to as a photoacoustic signal) corresponding to the first laser after interacting with the measured part. The physiological signals of the subject may then be determined based on the laser intensity and polarization variation signals and the ultrasonic signals. Specifically, the detection unit 130 may output the physiological signals of the subject based on the laser intensity and polarization variation signals (wherein the physiological signals may be understood as local magnetic field variations in the brain caused by neural discharges of the subject), and may output the blood oxygen signals of the subject based on the ultrasonic signals.

The detection unit 130 may be implemented using techniques such as magnetic field modulation and phase locked detection. The specific implementation may refer to related technical content, which will not be described in detail herein.

The target region 140 may be understood as the location of the measured part of the subject. The association between the measured part and the target region 140 means that the measured part of the subject is disposed at the target region.

It can be understood that since the second laser emission port 112 is optically aligned with the second laser entry port 121 of the atomic vapor cell 120, the second laser exit port 123 of the atomic vapor cell 120 is optically aligned with the laser receiving port 132-1 of the photodetector 132, and the detection port 122 of the atomic vapor cell 120 is optically aligned with the target region 140, the pulsed laser emitted from the second laser emission port 112 propagates through the atomic vapor cell 120 and is then detected by the photodetector 132. In this manner, the photodetector 132 can perform OPM-MEG detection based on the detected signal variations, which is equivalent to realizing an optically pumped magnetometer (e.g., OPM-MEG).

Since the first laser emission port 111 is optically aligned with the path control incident port 151, the path control emission port 152 is optically aligned with the target region 140, and the detection point 131-1 of the photoacoustic detector 131 is associated with the target region 140, the pulsed laser emitted from the first laser emission port 111 propagates through the laser path controller 150 and is directed to the target region 140. In this way, the photoacoustic detector 131 can perform photoacoustic detection based on variations in the detected photoacoustic signals, which is equivalent to realizing a photoacoustic sensor.

Furthermore, since the detection port of the atomic vapor cell 120 is optically aligned with the target region 140 and the detection point 131-1 of the photoacoustic detector 131 is associated with the target region 140, the pulsed lasers emitted from the second laser emission port 112 and the first laser emission port 111 can perform magnetic detection and photoacoustic detection of the same region, respectively, thereby achieving hardware reuse. As a result, hardware reuse enables multimodal fusion detection at the same location and at the same time, while also reducing the apparatus size and minimizing crosstalk among multimodal sensors.

Optionally, the laser emitted from the path control emission port 152 may at least partially overlap with the detection path of the atomic vapor cell 120 (not shown in FIG. 1). In this way, the degree of hardware reuse can be further improved, and specific examples may be referred to in the embodiments shown in FIGS. 2, 3, and 8.

It can be understood that, in the present application, at least one of the signal amplifier (AMP) and the data acquisition device (DAQ) may be reused according to practical application requirements, and the specific implementation of such reuse may be configured by a skilled person as needed, which will not be further described herein.

In the embodiments of the present application, the data acquisition device (DAQ) may also be replaced with a data processing device, a processor, or a data acquisition and processing device.

In addition, the balanced photodetector described herein may include partial accessories of two channels of signal amplifiers.

The detection path of the atomic vapor cell 120 may include a path from the detection port 122 to the target region 140.

In some possible embodiments, the laser generator 110 may be implemented using a single laser device. The pulsed laser generated by this laser device is split by a beam splitter to respectively obtain a second laser (which may may alternatively be implemented as second pulsed laser) and a first laser. The second laser satisfies the relaxation requirements of the optically pumped magnetometer principle when propagating through the atomic vapor cell, while the first laser satisfies the photoacoustic pressure requirements of photoacoustic imaging. For this embodiment, reference may be made to the apparatus illustrated in FIG. 2.

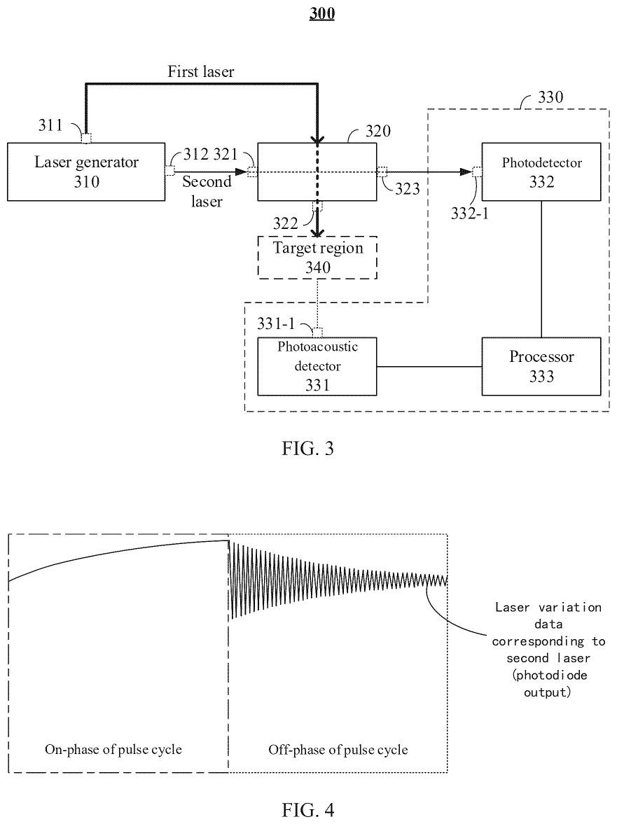

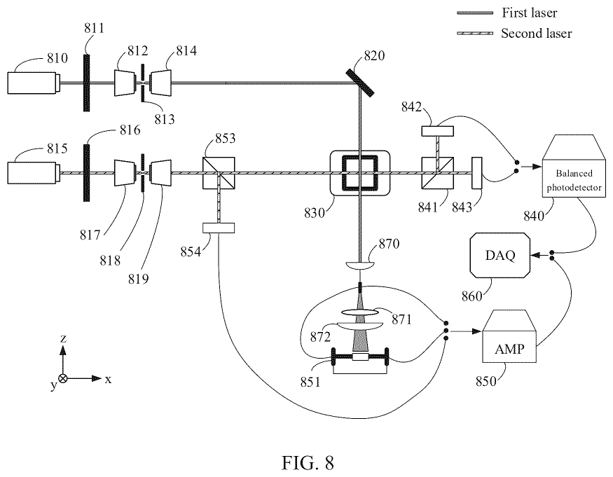

In some possible embodiments, the laser generator 110 may be implemented using two laser devices, which respectively generate the second laser and the first laser. Specifically, the laser generator 110 may comprise a detection laser device and an optical pumping laser device, wherein the detection laser serves as the light source for OPM-MEG, and the optical pumping laser serves as the light source for PAI. For this embodiment, reference may be made to the apparatus illustrated in FIG. 3 or FIG. 8.

Referring to FIG. 2, FIG. 2 illustrates another schematic structural diagram of a multimodal fusion detection apparatus based on optical pumping and photoacoustic imaging according to an embodiment of the present application. The specific explanations are as follows:

The apparatus 200 may comprise: a pulsed laser device 210, an optical filter 211, a focusing lens 212, a beam aperture 213, a focusing lens 214, a beam splitter 215, a beam splitter 216, a refractive lens 220, a collimating lens 221, an atomic vapor cell 230, a balanced photodetector 240, a beam splitter 241, a photodetection port 242, a photodetection port 243, a signal amplifier 250, an ultrasonic transducer 251, a reference photodetection port 253, a data acquisition device 260, a fiber coupler 270, an optical amplifier 271, and a diffuser 272.

The ultrasonic transducer 251 may, for example, be implemented using various forms of ultrasonic transducers or transducer arrays.

It can be understood that, depending on actual detection requirements, the apparatus 200 may further comprise more or fewer components not shown in FIG. 2. The specific configuration may be flexibly determined by those skilled in the art, and is not limited herein.

For the apparatus 200 shown in FIG. 2, the positional relationships, connection relationships, and coupling relationships among the respective devices and components may be referred to in FIG. 2 and will not be described in detail herein. The embodiments will be described below with reference to the propagation path of the pulsed laser.

For the laser propagation path of FIG. 2:

The pulsed laser device 210 may generate a laser, which propagates through the optical filter 211, the focusing lens 212, the beam aperture 213, and the focusing lens 214, and is then directed to the beam splitter 215. The beam splitter 215 splits the laser into two beams: a primary laser beam and a second primary beam. The primary laser beam is directed to the beam splitter 216, while the second primary beam is directed to the reference photodetection port 253.

The beam splitter 216 further splits the primary laser beam into two beams: a first primary sub-beam (corresponding to the second laser in the above embodiment) and a second primary sub-beam (corresponding to the first laser in the above embodiment). The first primary sub-beam is optically aligned with the atomic vapor cell 230, and after propagating through the atomic vapor cell 230, it is directed to the beam splitter 241. The beam splitter 241 further splits the first primary sub-beam into two beams, which are directed to the photodetection port 242 and the photodetection port 243, respectively. The photodetection port 242 and the photodetection port 243 are respectively connected to the balanced photodetector 240. According to the principle of OPM-MEG, the laser intensity of the first primary sub-beam after propagating through the atomic vapor cell 230 varies depending on the physiological signal changes of the measured part of the subject. The photodetection port 242 and the photodetection port 243 can acquire the laser intensity and polarization variation signals corresponding to the first primary sub-beam, and transmit these signals to the balanced photodetector 240 and the data acquisition device 260.

The second primary sub-beam is directed to the refractive lens 220. After being refracted by the refractive lens 220, the second primary sub-beam is optically aligned with the collimating lens 221. Subsequently, the second primary sub-beam propagates through the collimating lens 221 and is directed to the fiber coupler 270. After being received by the fiber coupler 270, the second primary sub-beam is guided to the optical amplifier 271 and the diffuser 272. After being processed by the optical amplifier 271 and the diffuser 272, the second primary sub-beam is directed toward the target region. At the target region, the second primary sub-beam interacts with the measured part of the subject, and the interaction generates a corresponding ultrasonic signal. The ultrasonic signal can be acquired by the ultrasonic transducer 251, and the acquired signal can then be transmitted to the signal amplifier 250 and the data acquisition device 260.

In the above process, the data acquisition device 260 can acquire both the laser intensity and polarization variation signals corresponding to the laser after propagating through the atomic vapor cell 230, and the ultrasonic signal corresponding to the interaction between the laser and the measured part. Further, the data acquisition device 260 may output the physiological signals of the subject according to the OPM-MEG principle based on the laser intensity and polarization variation signals, thereby realizing an optically pumped magnetometer; and may output the blood oxygen signals of the subject according to the PAI principle based on the ultrasonic signals, thereby realizing a photoacoustic sensor.

For the apparatus 200 shown in FIG. 2, the module composed of the pulsed laser device 210 (which may be referred to as a third pulsed laser) and the beam splitter 216, among others (for example, including but not limited to: the pulsed laser device 210, the optical filter 211, the focusing lens 212, the beam aperture 213, the focusing lens 214, the beam splitter 215, and the beam splitter 216), may be used to implement the laser generator 110 in the embodiment of FIG. 1. The emission position of the first primary sub-beam from the beam splitter 216 may correspond to the second laser emission port 112 in FIG. 1, and the emission position of the second primary sub-beam from the beam splitter 216 may correspond to the first laser emission port 111 in FIG. 1. The refractive lens 220 and the collimating lens 221 may implement the laser path controller 150 in FIG. 1. The incident position of the second primary sub-beam on the refractive lens 220 may correspond to the path control incident port 151 in FIG. 1, and the emission position of the second primary sub-beam from the collimating lens 221 may correspond to the path control emission port 152 in FIG. 1. The photodetection port 242, the photodetection port 243, and the balanced photodetector 240 may implement the photodetector 132 in the embodiment of FIG. 1. The ultrasonic transducer 251 and the signal amplifier 250 may implement the photoacoustic detector 131 in the embodiment of FIG. 1.

Other correspondences between the embodiments of FIG. 1 and FIG. 2 are not further described herein. The specific correspondence may be configured according to practical requirements.

Optionally, in the apparatus embodiment shown in FIG. 2, the irradiation path of the first laser may at least partially overlap with the detection path of the atomic vapor cell. Specifically, the path of the second primary sub-beam after being output from the fiber coupler 270 may partially or completely overlap with the detection path of the atomic vapor cell 230 (including the path from the detection port of the atomic vapor cell 230 to the target region). In this way, the degree of hardware reuse can be further improved.

According to the correspondence between the embodiment shown in FIG. 2 and the embodiment shown in FIG. 1, in some optional embodiments, the apparatus shown in FIG. 1 may include, in the laser generator 110, a third pulsed laser and a beam splitter. The third pulsed laser is configured to generate a third pulsed laser beam, and the beam splitter is configured to process the third pulsed laser beam into a second laser and a first laser. Optionally, the second laser is emitted via the second laser emission port 112 of the beam splitter, and the first laser is emitted via the first laser emission port 111 of the beam splitter.

The laser path controller 150 may be configured to direct the irradiation path of the second laser to propagate through the atomic vapor cell 120, and to direct the irradiation path of the first laser toward the target region 140. The atomic vapor cell 120 may be arranged to be associated with the target region 140. Furthermore, the photodetector 132, the photoacoustic detector 131, and the processor 133 may together constitute a detection unit 130. When the measured part of the subject is associated with the target region 140, the detection unit 130 may be configured to acquire the laser intensity and polarization variation signals corresponding to the second laser after propagating through the atomic vapor cell 120, as well as the ultrasonic signal corresponding to the interaction of the first laser with the measured part. The physiological signals of the subject may then be determined based on the laser intensity and polarization variation signals and the ultrasonic signals.

In some optional embodiments, for FIG. 1, the atomic vapor cell may be disposed between the path control emission port and the target region, such that the laser emitted from the path control emission port propagates through the atomic vapor cell and is then incident on the target region (not shown in FIG. 1). In other words, the irradiation path of the first laser is further configured to propagate through the atomic vapor cell and then be directed toward the target region. In this way, the degree of hardware reuse between the two detection techniques (OPM-MEG and PAI) can be further improved, and the apparatus size can be reduced.

Referring to FIG. 3, FIG. 3 illustrates yet another schematic structural diagram of a multimodal fusion detection apparatus based on optical pumping and photoacoustic imaging according to an embodiment of the present application. The multimodal fusion detection apparatus based on optical pumping and photoacoustic imaging includes: a laser generator 310, an atomic vapor cell 320, and a detection unit 330.

### 1. Laser Generator 310:

The laser generator 310 is capable of generating a first laser and a second laser. In optional embodiments, the laser generator 310 may include a laser device and a laser path controller (the specific implementation may be referred to in the relevant parts of the embodiments described below).

Optionally, the laser device in the laser generator 310 may adopt a distributed feedback (DFB) laser scheme or an external cavity diode laser (ECDL) scheme as a light source. The laser device may also serve as a seed laser for power amplification, where the amplification may be achieved using a tapered amplifier (TA) or a semiconductor optical amplifier (SOA).

The above laser may further include optical components such as an optical filter and/or a polarizer, which can be used to control the propagation path of the laser. The laser path controller is configured to control the propagation path of the laser to achieve path control. For example, the laser path controller may include a refractor, or alternatively, the laser path controller may include a refractor and a collimating lens.

In some optional embodiments, the laser path controller may further include an optical filter or a polarizer, thereby achieving control of the laser path.

### 2. Atomic Vapor Cell 320:

The atomic vapor cell 320 is a vapor cell based on the principle of an optically pumped magnetometer, providing a quantum medium sensitive to magnetic fields. For example, the atomic vapor cell 320 may be configured as a rubidium (87Rb) vapor cell. Depending on practical applications and implementation requirements, the atomic vapor cell 320 may further include a heating module (heating circuit), a modulation magnetic field generation module (modulation magnetic field circuit), and the like, which are not limited herein.

Optionally, the heating module of the atomic vapor cell 320 may be specifically implemented such that the atomic vapor cell 320 is heated to 100° C. by an alternating current (AC) heater driven at a frequency of 131.5 kHz. The AC heater is turned on during the ON phase of the pulsed cycle (i.e., the pumping period) and turned off during the OFF phase of the pulsed cycle (i.e., the measurement period) to reduce magnetic noise generated by the heater.

During the OFF phase of the pulsed cycle, the detection of the laser variation data corresponding to the second laser may be performed by zero-crossing detection or phase locked detection. Specifically, after the pumping period, the pumping beam is turned off, and a linearly polarized probe beam is used to measure the free induction decay (FID) signal of spin precession by employing zero-crossing detection.

Optionally, the modulation magnetic field generation module may be specifically implemented with a polarization coil configured to apply a modulation magnetic field to the atomic vapor cell according to preset modulation parameters. For example, a rotating magnetic field with an amplitude of about ˜18 μT and a frequency of ωm=2π×480 Hz may be applied, together with a longitudinal guiding magnetic field Bz. The total amplitude of the applied magnetic field is maintained at about ˜50 μT.

It can be understood that the atomic vapor cell 320, the photodetector 332, and other possible modules (such as the heating module, the modulation magnetic field generation module, etc.) cooperate with each other to realize the function of an atomic magnetometer (e.g., an OPM sensor).

### 3. Detection Unit 330:

The detection unit 330 may include: a photoacoustic detector 331, a photodetector 332, and a processor 333.

The photoacoustic detector 331 is configured to detect photoacoustic wave signals, and may cooperate with the processor 333 to perform blood oxygen signal detection based on photoacoustic imaging using the laser generated by the laser generator 310.

The photodetector 332 is capable of converting optical signals into electrical signals for detecting laser variation data parameters (e.g., laser intensity variation, laser frequency signal, etc.). The photodetector 332 may cooperate with the atomic vapor cell 320 and the processor 333 to perform electromagnetic physiological signal detection based on an optically pumped magnetometer using the laser generated by the laser generator 310.

The processor 333 is configured to process input data according to a preset algorithm program, so as to achieve corresponding algorithmic objectives and output data calculated by the algorithm. The processor may include, but is not limited to: at least one processing core configured to execute the algorithm program corresponding to the method of the present application; a memory storing computer program code for achieving the algorithmic objectives, the memory being in communication with the processing core; and functional modules for implementing the steps of the algorithm, the functional modules being configured by the computer program code to cause the processing core execute the corresponding method embodiments provided in the present application.

In FIG. 3, the laser generator 310 may include a first laser emission port 311 and a second laser emission port 312. The atomic vapor cell 320 may include a laser entry port 321, a laser exit port 323, and a detection port 322. The detection path of the atomic vapor cell 320 may include a path from the detection port 322 to the target region 340. The photoacoustic detector 331 may include a detection point 331-1. The photodetector 332 may include a laser receiving port 332-1. The photoacoustic detector 331 and the photodetector 332 may be electrically connected to the processor 333, respectively.

The detection port 322 is an optical window of the atomic vapor cell 320, which allows optical signals to propagate through.

The laser receiving port 332-1 may serve as a first detection position of the detection unit 330 (also referred to as an optical pumping detection position), and the detection point 331-1 may serve as a second detection position (also referred to as a photoacoustic detection position).

In FIG. 3, the irradiation path of the first laser may be configured, via the laser path controller, to propagate through the atomic vapor cell 320 and then be directed toward the target region 340. Similarly, the irradiation path of the second laser may be configured, via the laser path controller, to propagate through the atomic vapor cell 320 and then be directed toward the first detection position of the detection unit 330.

In the embodiments of the present application, the atomic vapor cell 320 may be configured to be associated with the target region 340. That is, the atomic vapor cell 320 may be configured to detect the target region 340. For example, the detection path of the atomic vapor cell 320 may be configured to be directed toward the target region 340. Specifically, in FIG. 3, the detection port 322 is optically aligned with the target region 340. In addition, the detection point 331-1 is associated with the target region 340.

For the embodiment, the following should be noted:
1. In the embodiment, optical alignment may include: direct alignment between object A and object B, or indirect alignment between object A and object B via optical components. For example, the alignment described herein may be interpreted as follows: a laser beam is emitted from point A and directly aligned with point B; or, a laser beam is emitted from point A and, after its direction is changed by some optical components, is optically aligned with point B.
2. In the embodiment, the alignment shown in FIG. 3 is merely an example and does not limit the alignment between various modules, units, or components. The alignment between one laser emission/entry port and another laser emission/entry port may be direct alignment or indirect alignment.
3. In the embodiment, the association between the detection point 331-1 and the target region 340 may be understood as the detection point 331-1 being disposed near, around, or within the target region 340, without limitation. The association of the detection point 331-1 with the target region 340 enables the photoacoustic detector 331 to perform detection of the target region 340.

In the embodiments of the present application, the detection unit 330 may be implemented using techniques such as magnetic field modulation and lock-in detection, which can be referred to in the related technical literature and are not described in detail herein.

The target region 340 may be understood as a designated location of the measured part of the subject. The association between the measured part and the target region 340 means that the measured part of the subject is positioned within the target region.

For the multimodal fusion detection apparatus based on optical pumping and photoacoustic imaging provided by the present application, the pulsed characteristics of the laser source not only affect the thermal deposition mode and signal waveform of PAI, but also directly determine whether OPM employs continuous pumping to excite alkali-metal atoms into the spin-exchange relaxation-free (SERF) state for measurement, or pulsed pumping combined with the free induction decay (FID) theory to perform magnetic field detection. Accordingly, for the multimodal fusion detection apparatus including, for example, the structure shown in FIG. 3, the first laser may be configured as a pulsed laser, or alternatively as a continuous-wave (CW) laser or a quasi-continuous-wave (QCW) laser. Depending on the laser configuration, the specific implementation of the multimodal fusion detection apparatus may include the following Scheme 1 and Scheme 2.

### Scheme 1:

In the case where the first laser is configured as a pulsed laser, the multimodal fusion detection apparatus (which may operate either in a magnetically shielded environment or in a non-shielded environment) is as follows:

The laser generator 310 generates the first laser, which is configured as a pulsed laser.

The irradiation path of the first laser may be configured to propagate through the atomic vapor cell 320 and then be directed toward the target region 340. The sequential order of the first laser path includes: the first laser emission port 311→the entry port of the atomic vapor cell 320→the atomic vapor cell 320→the detection port 322→the target region 340.

The entry port of the atomic vapor cell 320 is similar to the detection port 322 and serves as an optical window of the atomic vapor cell 320, allowing optical signals to propagate through.

As shown in FIG. 4, the first laser is used to excite atoms in the atomic vapor cell 320 into an excited state during the ON phase of the pulsed cycle. The laser generator 310 is further configured to generate the second laser at least during the OFF phase of the pulsed cycle of the first laser. The sequential order of the second laser path includes: the second laser emission port 312→the laser entry port 321→the atomic vapor cell 320→the laser exit port 323→the laser receiving port 332-1→the photodetector 332.

The irradiation path of the second laser is configured to propagate through the atomic vapor cell 320 and then be directed toward the first detection position (i.e., the laser receiving port 332-1) of the detection unit 330. Moreover, the wavelength of the second laser is configured to be different from (e.g., away from) the atomic excitation wavelength of the atomic vapor cell. In other words, the wavelength of the second laser is configured to be different from (e.g., away from, with specific offset values being referenced in the laser parameter examples described below) the wavelength of the first laser.

The detection unit 330 is configured to: when the measured part of the subject is associated with the target region 340, acquire the photoacoustic signal data corresponding to the interaction of the first laser with the measured part; acquire, via the first detection position, the laser variation data corresponding to the second laser after propagating through the atomic vapor cell 320; and determine the physiological signal of the subject based on the laser variation data and the photoacoustic signal data.

In this embodiment, determining the physiological signal of the subject based on the laser variation data and the photoacoustic signal data includes: determining the electromagnetic physiological signal of the subject according to the laser variation data; and determining the blood oxygen signal of the subject according to the photoacoustic signal data.

The laser variation data may include one or more of the following: the laser frequency, intensity, polarization signal, zero-crossing, phase signal, etc., of the second laser after propagating through the atomic vapor cell.

The amplitude or frequency of Larmor precession, as well as the magnetic field modulation signal, may be obtained based on laser signal observation schemes including, but not limited to, lock-in detection, zero-crossing tracking, and peak-to-peak detection.

In the present application, the electromagnetic physiological signal (corresponding to neuronal electrical activity) may be described as: “an electromagnetic physiological signal generated by synchronous dendritic currents within a neuronal cluster.” The electromagnetic physiological signal may alternatively be referred to as an electrophysiological signal or a magnetophysiological signal. Specifically, for the non-invasive capture of neuronal electric/magnetic fields, the neuronal population should form a functional entity (i.e., a neuronal cluster). This is because a sufficiently large group of neurons tends to gradually operate in a coordinated manner and be spatially organized, wherein the dendrites of multiple neurons simultaneously generate currents. Such synchrony can significantly amplify the electrical signals, resulting in local field potentials (LFPs) and local magnetic fields (LMFs), collectively referred to as cortical sources (CSs) of electromagnetic physiological signals, which form the theoretical basis of electroencephalogram (EEG) and magnetoencephalogram (MEG) signal measurements, wherein the electromagnetic physiological signal includes both electrophysiological and magnetophysiological signals.

The blood oxygen signal may be described as “variations in regional cerebral blood flow (rCBF) or cerebral metabolic rate of oxygen (CMRO2),” which can be used to map neuronal or muscular activity. In the embodiments of the present application, after the photoacoustic signal is determined, the determination of the blood oxygen signal based on the photoacoustic signal may be implemented with reference to related technologies, and details are not repeated herein.

In the present application, the photoacoustic detector 331, the photodetector 332, and the processor 333 may together form the detection unit 330. The detection unit 330 may, when the measured part of the subject is associated with the target region 340, acquire the laser variation data corresponding to the second laser after propagating through the atomic vapor cell 320, as well as the photoacoustic signal data corresponding to the interaction of the first laser with the measured part. The detection unit 330 is then configured to determine the electromagnetic physiological signal of the subject based on the laser variation data and the photoacoustic signal data. Specifically, the detection unit 330 may output the electromagnetic physiological signal of the subject (i.e., an electrophysiological signal, which may be understood as local magnetic field variations in the subject's brain, or alternatively in other body regions, induced by neuronal discharges) based on the laser variation data (including laser frequency signals), and may output the blood oxygen signal of the subject based on the photoacoustic signal.

For photoacoustic imaging, according to photoacoustic theory, the laser-induced photoacoustic signal is primarily affected by two temporal constants: the stress relaxation time τₛ and the thermal relaxation time τₜₕ. When the laser pulse width satisfies

$$\{ \begin{matrix}Δ t > {τ}_{s} \\ Δ t > {τ}_{t h}\end{matrix} ,$$

the photoacoustic signal can be approximated as being induced by a single “short pulse.” Otherwise, it will enter a region dominated by thermal accumulation (Grüneisen saturation term) or a region dominated by thermal diffusion, which will significantly alter the structural characteristics of the PAI signal and its interaction with MEG. Accordingly, in the embodiments of the present application, the pulse width of the first laser may be selected from any one of the following ranges: a first range, a second range, and a third range.

The first range is configured such that: stress relaxation time<pulse width<first empirical value<thermal relaxation time. Specifically, the first empirical value may be 10 ns, or a value slightly greater or smaller than 10 ns. Thus, the first range is configured as: stress relaxation time<pulse width<first empirical value<<(much less than) thermal relaxation time.

The second range is configured such that: first empirical value<pulse width<second empirical value<thermal relaxation time. Specifically, the second empirical value may be 100 ns, or a value slightly greater or smaller than 100 ns. Thus, the second range is configured as: first empirical value<pulse width<second empirical value<<(much less than) thermal relaxation time.

The third range is configured such that: pulse width≥thermal relaxation time.

For the first range:

When the pulse width of the first laser is selected within the first range, the multimodal fusion detection apparatus may be specifically implemented as follows (also referred to as a quasi-transient short-pulse implementation):

First, within the first range, the laser pulse width is typically less than 10 ns. Denoting the pulse width as Δt, then Δt<10 ns<<thermal relaxation time τₜₕ, and the first empirical value may be set to 10 ns. Referring to FIG. 5, when the pulse width of the first laser is selected within the first range, the photoacoustic pressure signal transmitted as a photoacoustic signal corresponding to the interaction of the first laser with the measured part exhibits a positive-negative pulse pattern. The heat deposition process can be regarded as an instantaneous injection, and the PAI signal presents a typical positive-negative pulse shape with virtually no thermal diffusion tailing. Under these conditions, PAI imaging provides good thermal localization and a single positive-pulse response characteristic. In this case, the multimodal fusion detection apparatus may adopt an FID-OPM combined with a conventional pulsed-PAI architecture, wherein the laser pulse serves as a unified trigger source to simultaneously excite the photoacoustic signal and synchronously initiate MEG signal acquisition, thereby achieving natural spatial and temporal coupling of the two modalities.

The first range may be determined in the following manner: when the photoacoustic pressure signal transmitted as a photoacoustic signal corresponding to the interaction of the first laser with the measured part exhibits a positive-negative pulse pattern, the corresponding pulse width range is defined as the first range. In other words, the maximum value and the minimum value of the first range are determined according to the first characteristic exhibited by the first laser, wherein the first characteristic comprises that the photoacoustic pressure signal transmitted as a photoacoustic signal corresponding to the interaction of the first laser with the measured part presents a positive-negative pulse pattern.

When the pulse width of the first laser is selected within the first range, the blood oxygen signal of the subject may be determined according to the following first formula:

$${p}_{1} = {Γ}_{0} {η}_{t h} {μ}_{a} ϕ δ t$$

wherein p₁ represents the photoacoustic signal, Γ₀ represents a Grüneisen coefficient at ambient temperature, ηₜₕ represents a conversion efficiency from heat to acoustic energy, μₐ represents an optical absorption coefficient, φ represents an optical irradiation intensity (with a unit of W/cm²), and δt represents an optical irradiation time.

It should be noted that this pulse width range (the first range) has minimal modulation impact on FID-OPM, while being the most efficient for PAI imaging, thereby enabling the most compact system integration.

For the second range:

When the pulse width of the first laser is selected within the second range, the multimodal fusion detection apparatus may be specifically implemented as follows (also referred to as a thermal accumulation (Grüneisen saturation term) dominated implementation):

When the pulse width of the first laser is selected within the second range, for the photoacoustic pressure signal transmitted as a photoacoustic signal corresponding to the interaction of the first laser with the measured part, the amplitude of the negative photoacoustic pulse is greater than that of the positive photoacoustic pulse. Referring to FIG. 6, when the laser pulse width exceeds 10 ns, the negative photoacoustic pulse P2 may exhibit a larger amplitude than the first signal P1. This may be due to greater energy deposition in the object, resulting in an increased Grüneisen coefficient (an increase in the thermal expansion coefficient) caused by a rise in the object's temperature. As the laser pulse width increases, the amplitude of the second negative photoacoustic pulse P2 correspondingly increases, until thermal saturation occurs (since the pulse width is still much less than the thermal relaxation time τₜₕ).

In other words, the second range may be determined as follows: when the photoacoustic pressure signal transmitted as a photoacoustic signal corresponding to the interaction of the first laser with the measured part exhibits that the amplitude of the negative photoacoustic pulse is greater than that of the positive photoacoustic pulse, the corresponding pulse width range is defined as the second range. That is, the maximum and minimum values of the second range are determined according to a second characteristic exhibited by the first laser, wherein the second characteristic comprises that the amplitude of the negative photoacoustic pulse of the photoacoustic pressure signal corresponding to the interaction of the first laser with the measured part is greater than that of the positive photoacoustic pulse.

When the pulse width of the first laser is selected within the second range, the blood oxygen signal of the subject is determined according to the following second formula:

$${p}_{2} = \{ {Γ}_{0} + b {η}_{t h} {μ}_{a} {τ}_{t h}^{2} ϕ [ 1 - ( 1 + \frac{Δ t}{{τ}_{t h}} ) {e}^{- \frac{Δ t}{{τ}_{t h}}} ] \} {η}_{t h} {μ}_{a} ϕ δ t + {Γ}_{0} {η}_{t h} {μ}_{a} \cdot ϕΔ t \cdot {e}^{- \frac{Δ t}{{τ}_{t h}}} ;$$

Wherein p₂ represents the photoacoustic signal, Γ₀ represents a Grüneisen coefficient at ambient temperature, ηₜₕ represents a conversion efficiency from heat to acoustic energy, μₐ represents an optical absorption coefficient, φ represents an optical irradiation intensity, δt represents an optical irradiation time, b represents a proportionality coefficient relating absorbed thermal energy to variations of the Grüneisen parameter, At represents a pulse width of laser, and τₜₕ represents a thermal relaxation time.

In this case, there is no positive optimal laser pulse width, wherein the Grüneisen saturation term

$$( b {η}_{t h}^{2} {μ}_{a}^{2} {ϕ}^{2} δ t [ 1 - ( 1 + \frac{Δ t}{{τ}_{t h}} ) {e}^{- \frac{Δ t}{{τ}_{t h}}} ] )$$

dominates, and the second formula may be simplified as follows:

$${p}_{2} = {p}_{1} + b {η}_{t h}^{2} {μ}_{a}^{2} {ϕ}^{2} δ t {τ}_{t h}^{2} [ 1 - ( 1 + \frac{Δ t}{{τ}_{t h}} ) {e}^{- \frac{Δ t}{{τ}_{t h}}} ] ;$$

$$wherein {p}_{1} = {Γ}_{0} {η}_{t h} {μ}_{a} ϕδ t ;$$

At this time, the OPM performs detection based on the FID theory. The intensity of the negative pulse P2 expected to appear in the PAI signal is greater than that of the positive pulse P1. It is therefore recommended to use positive-negative pulse differencing, or to directly measure the negative pulse for photoacoustic image reconstruction, so as to improve contrast and system stability.

For the case of the second range, typical FID values generally fall within this range, and the pulse length is preferably set to 40.25 ns. At this pulse width, the excitation length can achieve optimal pumping efficiency, and the detection frequency is around 1 kHz, which is sufficient to meet the requirements of neural detection in the brain.

When the pulse width of the first laser is selected within the third range, the multimodal fusion detection apparatus is implemented as follows (thermal diffusion-dominated regime)

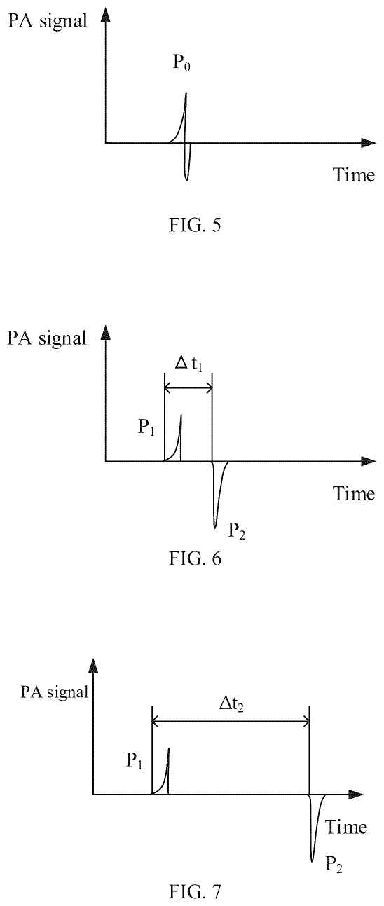

When the pulse width of the first laser is selected within the third range, for the photoacoustic pressure signal propagated in response to the interaction between the first laser and the measured site, the amplitude of the negative photoacoustic pulse exhibits a trend of first increasing and then decreasing. Referring to FIG. 7, when the laser pulse width exceeds the thermal relaxation time, namely Δt≥τₜₕ, at this time, the amplitude of the negative pulse component in the PAI signal presents a trend of ‘first increasing and then decreasing,’ and a distinct optimal laser pulse width exists.

The third range can be determined in the following manner: when, for the photoacoustic pressure signal propagated in response to the interaction between the first laser and the measured site, the amplitude of the negative photoacoustic pulse exhibits a trend of initially increasing and subsequently decreasing, the corresponding pulse width range is defined as the third range. That is, the maximum and minimum values of the third range are determined according to the third characteristic exhibited by the first laser, wherein the third characteristic includes that, for the photoacoustic pressure signal propagated in response to the interaction between the first laser and the measured site, the amplitude of the negative photoacoustic pulse exhibits a trend of initially increasing and subsequently decreasing.

For the third range:

when the pulse width of the first laser is selected within the third range, the blood oxygen signal of the subject can be determined according to the following third equation:

$${p}_{2} = {Γ}_{0} {η}_{t h} {μ}_{a} ϕ \cdot Δ t \cdot {e}^{- \frac{Δ t}{{τ}_{t h}}}$$

wherein p₂ represents the photoacoustic signal, Γ₀ represents a Grüneisen coefficient at ambient temperature, ηₜₕ represents a conversion efficiency from heat to acoustic energy, μₐ represents an optical absorption coefficient, φ represents an optical irradiation intensity, Δt represents a pulse width of laser, and τₜₕ represents a thermal relaxation time. In this case,

$${Γ}_{0} {η}_{t h} {μ}_{a} ϕ >> b {η}_{t h}^{2} {μ}_{a}^{2} {ϕ}^{2} δ t \cdot {τ}_{t h} .$$

It should be understood that the proper selection of the laser pulse width is crucial for maximizing the nonlinear PA signal. More importantly, the key pulse width Δt₀ is a unique parameter that characterizes the thermal nonlinearity of different materials and can be further used for contrast-enhanced imaging. This also means that Δt₀ differ across different materials, requiring a scan of the pulse width At and an analysis of whether the amplitude of P2 meets the expectation of the third equation.

Optionally, when the pulse width of the first laser is selected within the first range, the pulse width of the first laser is determined according to a first optical pumping reference pulse width. For example, the pulse width of the first laser may be set to equal or approximate 8 ns, 10 ns, 12 ns, 14 ns, and the like (the first optical pumping reference pulse width).

When the pulse width of the first laser is selected within the second range, the pulse width of the first laser is determined according to a second optical pumping reference pulse width. For example, For example, the pulse width of the first laser may be set to equal or approximate 40.25 ns, such as 40 ns, 41 ns, 40.24 ns, 40.25 ns, or 40.26 ns (the second optical pumping reference pulse width).

When the pulse width of the first laser is selected within the first range or the second range, the highest pumping efficiency can be achieved by setting the first optical pumping reference pulse width/the second optical pumping reference pulse width.

When the pulse width of the first laser is selected within the third range, the optimal pulse width of the first laser is determined according to the thermal relaxation time. For example, the optimal pulse width of the first laser may be set to equal or approximate the thermal relaxation time. When the pulse width of the first laser is selected within the third range, setting the value of the pulse width of the first laser to be the same as the value of the thermal relaxation time can achieve the optimal photoacoustic effect.

After calculating the corresponding photoacoustic signal according to the above first formula, second formula, or third formula, the blood oxygen signal of the subject can then be calculated based on the photoacoustic signal. Reference may be made to related techniques, and no further details are provided herein.

It can be understood that the irradiation path of the first laser is configured to propagate through the atomic vapor cell 320 and then aim at the target region 340. When the measured part of the subject is associated with the target region 340, the detection unit 330 can perform photoacoustic (PA) detection based on the photoacoustic signal data corresponding to the interaction of the first laser with the measured part, thereby functioning as a photoacoustic sensor. The first laser is further configured to drive the atoms in the atomic vapor cell 320 into an excited state during the on phase of the pulse cycle; after the atoms are driven into the excited state, a second laser propagating through the atomic vapor cell 320 is generated during the off phase of the pulse cycle, and the wavelength of the second laser is configured to be different from the atomic excitation wavelength of the atomic vapor cell 320. In this way, by collecting the laser variation data of the second laser after propagating through the atomic vapor cell 320, the detection unit 330 can perform magnetic field detection based on the detected signal variations, thereby functioning as an optically pumped magnetometer (OPM). Since the irradiation path of the first laser is configured to propagate through the atomic vapor cell 320 toward the target region 340, and the irradiation path of the second laser is configured to propagate through the atomic vapor cell 320 toward the first detection position of the detection unit 330, it follows that the detection path of the atomic vapor cell 320 can be used both for magnetic field detection and photoacoustic detection. As a result, simultaneous acquisition of magnetic field signals and photoacoustic signals at a single detection point can be realized, enabling hardware reuse to achieve multimodal fusion detection at the same location (without physical competition between devices), with intrinsic temporal synchronization (without the need for timestamps or multi-device information communication), high spatiotemporal resolution, and noninvasiveness. At the same time, the device size can be reduced, crosstalk between multimodal sensors can be minimized, and coupling studies of neural activity and blood flow conditions can be achieved.

In addition, in the embodiments of the present application, by using the first laser to drive the atoms in the atomic vapor cell into an excited state, and by employing a second laser during the off period of the first laser, wherein the wavelength of the second laser is different from the atomic excitation wavelength of the atomic vapor cell (meaning that the wavelength of the second laser is configured to be away from that of the first laser), an optically pumped magnetometer can be realized, thereby avoiding pump light interference and improving the signal-to-noise ratio. Furthermore, by sharing the light source architecture between PAI and OPM, photoacoustic imaging and magnetic field measurement are fused, enabling a noninvasive and long-term wearable fusion detection device (for example, a brain-computer interface).

In an optional embodiment, the atomic vapor cell 320 includes a polarization coil. The polarization coil is configured to apply a modulation magnetic field to the atomic vapor cell according to preset modulation parameters. Accordingly, the above step of determining the subject's electromagnetic physiological signal based on the laser variation data may include: determining, based on the preset modulation parameters and the laser variation data (e.g., including a laser frequency signal), one or more data of the subject, comprising an electromagnetic physiological signal in vector dimensions or a magnetic field modulation signal. In this way, vector detection can be achieved through the scheme of magnetic field modulation.

In an optional embodiment, the laser generator is further configured to generate the second laser during time periods other than the off phase of the pulse cycle of the first laser.

In an optional embodiment, the output of the first laser is set to a square-wave mode.

In an optional embodiment, the irradiation path of the first laser after propagating through the atomic vapor cell 320 at least partially overlaps with the detection path of the atomic vapor cell. Specifically, the path of the first laser from the detection port 322 of the atomic vapor cell 320 to the target region 340 can partially or completely overlap with the detection path of the atomic vapor cell (including the path from the detection port 322 of the atomic vapor cell 320 to the target region 340). FIG. 3 illustrates a complete overlap, but the present application is not limited to complete overlap; partial overlap can also be implemented. In this way, the degree of hardware reuse can be further improved, and reference can be made to the embodiment shown in FIG. 8 for details.

It can be understood that, in the present application, at least one of the signal amplifier (AMP) and the data acquisition device (DAQ) may be reused according to actual application requirements. The specific implementation of such reuse may be configured by a skilled person as needed, and will not be further detailed herein.

In the present description, the balanced photodetector may include certain accessories comprising two channels of signal amplifiers.

In an optional embodiment, the multimodal fusion detection apparatus based on optical pumping and photoacoustic imaging (the apparatus described in Scheme 1) is configured to operate in a non-magnetically shielded environment or within magnetic compensation coils.

It should be noted that, in the prior art, all measurements using wearable SERF magnetometers have been conducted in magnetically shielded rooms, whereas the optically pumped gradiometer based on the FID theory (i.e., the apparatus described above) proposed in the present application is capable of detecting magnetoencephalography (MEG) and magnetocardiography (MCG) signals in the Earth's magnetic field while exposed to natural magnetic noise sources.

In an optional embodiment, when the pulse width of the first laser is selected within the third range, the first laser is further configured to perform subcutaneous thermotherapy on the measured site, wherein the accumulated laser energy can induce a tissue temperature rise of several tens of degrees, thereby enabling thermotherapy induction and temperature feedback imaging to be carried out in parallel with biomagnetic field detection.

Regarding the apparatus described in Scheme 1, the following presents part of the derivation concerning the energy attenuation mechanism of the laser after propagating through the atomic vapor cell. Based on this derivation, it can be concluded that the first laser in the apparatus 1 supports photoacoustics:
1.1, Superposition of the “transparent after pumping” state

After right-circularly polarized o optical pumping, the spin S points toward +z (similarly for left-circular polarization), with the following equation:

$$\frac{d I}{d z} = - n {σ}_{a b s} I ( 1 - {sS}_{z} ) , s = + 1 \qquad ( 6 )$$

1.2 Superposition of “strong-light saturation” state

When using the FID method, the intensity is generally much greater than Iₛₐₜ, the transition is almost fully occupied, and the absorption cross-section is reduced according to 1/(1+I/Iₛₐₜ):

$$\frac{d I}{d z} = - n {σ}_{a b s} \frac{{I}_{0} ( 1 - s {S}_{z} )}{1 + I / {I}_{s a t}} \qquad ( 7 )$$

Wherein the saturation intensity is defined as when the light intensity I=Iₛₐₜ, the ground state and the excited state each occupy 50%. When the FID resonance excitation is applied, the excitation of Iₛₐₜ can be simply considered as being free from decoherence, and thus the Iₛₐₜ can be simplified as follows:

$${I}_{s a t} = \frac{π h c Γ}{3 {λ}^{3}} \qquad ( 8 )$$

where h denotes the Planck constant, c denotes the speed of light, Γ denotes the linewidth, and λ denotes the wavelength (for example, 795 nm);

In summary, the differential expression for the pumping segment under the FID mode is obtained as Equation (7). However, the currently corresponding and usable form is the differential for a continuous light source, and it is still necessary to perform integration for the pulse format used in the experimental design. The detailed procedure is provided below.
2. Integration in the time domain and over the area to obtain the attenuation formula of the ‘pulse fluence’ (here, a single square pulse with a duration of τₚᵤₘₚ is taken as an example; multiple pulses and pulses of different shapes follow analogously).
2.1. Definition of variables and assumptions:

Define the pulse fluence (i.e., “energy density per unit area”):

$$F ≡ {\int }_{0}^{{τ}_{pump}} I ( t ) dt , [ J / {cm}^{2} ] \qquad ( 9 )$$

Obtain the saturation pulse fluence under the condition Iₛₐₜ:

$${F}_{s a t} = {I}_{s a t} {τ}_{pump} \qquad ( 10 )$$

Assume that the pulse duration τₚᵤₘₚ is appropriately chosen (according to selection principles of the first to third ranges described above) and that the pumping result within the pulse is effective, the z-axis component of the atomic spin polarization at the trailing edge of the square pulse, denoted by τₚᵤₘₚ, is pumped close to 1 (pumping completed, entering the state described in Section 1.2).

Assume that, during pumping, the concentration and temperature in the Rb vapor cell are uniform and constant;
2.2 Integration along the z-axis and time t

$${F}_{out} = {F}_{i n} exp [ - \frac{O {D}_{0} ( 1 - s {S}_{z} )}{1 + {F}_{in} / {F}_{s a t}} ] , {OD}_{0} = n {σ}_{a b s} 1 \qquad ( 11 )$$

Where OD₀ denotes the unpolarized optical depth;
(1−sS_{z}) denotes the pumping suppression term, which approaches 0 in the case of complete transparency as described in Section 1.2, i.e., at the trailing edge of the square pulse, Fₒᵤₜ tends to Fᵢₙ;
1+Fᵢₙ/Fₛₐₜ denotes the pulse saturation term, when Fᵢₙ>>Fₛₐₜ, the energy absorption rate of the atomic vapor cell decreases significantly and Fₒᵤₜ tends to Fᵢₙ.
2.3 Countermeasures for insufficient Fₒᵤₜ
1. Increase the input pulse energy.
2. Reduce OD₀, which can be achieved by shortening the cell length l or lowering the temperature T. However, both approaches have drawbacks: shortening the cell length reduces the signal-to-noise ratio (SNR), while lowering the temperature decreases the sensitivity.
3. Apply a reflective coating to the atomic vapor cell to enable multiple reflections.

Scheme 2: In the case where the first laser is configured as a continuous-wave (CW) laser or a quasi-continuous-wave (QCW) laser, the multimodal fusion detection apparatus (which can operate in a magnetically shielded environment) is implemented as follows:

The laser generator 310 generates the first laser, the first laser being configured as a continuous-wave (CW) laser or a quasi-continuous-wave (QCW) laser.

The irradiation path of the first laser may be configured to propagate through the atomic vapor cell 320 and then point toward the target region 340. The sequential order of the first laser path includes: first laser emission port 311→laser entry port of the atomic vapor cell 320→atomic vapor cell 320→detection port 322→target region 340.

Herein, a continuous-wave (CW) laser device specifically refers to a device capable of providing uninterrupted laser output during operation. A quasi-continuous-wave (QCW) laser device, on the other hand, operates in an intermittent emission mode, which is different from the uniform energy distribution of a single-mode continuous laser. The energy distribution of a QCW laser generator is more concentrated, which means it possesses higher energy density, thereby achieving stronger penetration capability.

The first laser is used to drive the atoms in the atomic vapor cell 320 into an excited state.

The laser generator 310 is further configured to generate a second laser. The propagation path of the second laser is sequentially arranged as follows: the second laser emission port 312→laser entry port 321→atomic vapor cell 320→laser exit port 323→laser receiving port 332-1→photodetector 332.

The irradiation path of the second laser is configured to be directed, after propagating through the atomic vapor cell 320, toward the first detection position of the detection unit 330 (the laser receiving port 332-1). Furthermore, the wavelength of the second laser is configured to be offset from the atomic excitation wavelength of the atomic vapor cell. In other words, the wavelength of the second laser is configured to be offset from that of the first laser.

The detection unit 330 is configured to: when the measured part of the subject is associated with the target region 140, acquire the photoacoustic signal data corresponding to the interaction between the first laser and the measured part; acquire, at the first detection position, the laser variation data corresponding to the second laser after propagating through the atomic vapor cell 320; and determine the physiological signals of the subject based on the laser variation data and the photoacoustic signal data.
wherein determining the physiological signals of the subject based on the laser variation data and the photoacoustic signal data, comprising: determining the electromagnetic physiological signals of the subject according to the laser variation data; and determining the blood oxygen signal of the subject according the photoacoustic signal data.

The laser variation data includes, for example, laser intensity and polarization variation signals corresponding to the second laser after propagating through the atomic vapor cell.

Specifically, the photoacoustic detector 331, the photodetector 332, and the processor 333 can together serve as the detection unit 330. The detection unit 330, when the measured part of the subject is associated with the target region 340, can acquire the laser variation data corresponding to the second laser after propagating through the atomic vapor cell 320, and can also acquire the photoacoustic signal data corresponding to the interaction between the first laser and the measured part. The physiological signals of the subject are then determined based on the laser variation data and the photoacoustic signal data. In particular, the detection unit 330 can output the subject's electromagnetic physiological signals (which may be understood as local magnetic field variations in the subject's brain, or in other body regions, caused by neuronal discharges) according to the laser variation data (including laser intensity and polarization variation signals), and can output the subject's blood oxygen signals according to the photoacoustic signals.

When the system employs a continuous-wave (CW) or quasi-continuous-wave (quasi-CW) laser source, in addition to the thermal accumulation and diffusion occurring within a single laser pulse, the long-term thermal accumulation and the rise of the baseline temperature may also become significant as the laser pulse repetition rate (N pulses per second, pulse interval τₚᵢ=1/n) increases. Both p1 and p2 will be influenced by an additional quasi-CW temperature rise and saturation term, which is a function of the number of pulses n. In the quasi-continuous-wave mode, the photoacoustic (PA) signals can thus be expressed as the superposition of the linear and nonlinear PA signals p_{1,2} induced by the previous single pulses, together with the quasi-CW temperature rise and saturation term. Accordingly, in this embodiment, determining the blood oxygen signal of the subject based on the photoacoustic signal data may include: determining the blood oxygen signal of the subject according to the following fourth equation:

$${p}_{qCW 1 , 2} = {p}_{1 , 2} + B {τ}_{t h}^{2} \{ 1 [ 1 + \frac{( n - 1 ) ( {τ}_{t h} - {τ}_{pi} )}{{τ}_{t h}} ] {e}^{- \frac{( n - 1 ( {τ}_{t h} - {τ}_{p i} )}{{τ}_{t h}}} \} , {τ}_{t {h}^{-}} {τ}_{p i} > 0$$

wherein P_{qCW1,2} represents the photoacoustic signal, p_{1,2} represents a difference between a leading edge and a trailing edge of the photoacoustic signal, B represents

$$b {η}_{t h}^{2} {μ}_{a}^{2} {φ}^{2} δ t ,$$

b represents a proportionality coefficient relating absorbed thermal energy to variations of the Grüneisen parameter, ηₜₕ represents a conversion efficiency from heat to acoustic energy, μₐ represents an optical absorption coefficient, φ represents an optical irradiation intensity, δt represents an optical irradiation time, n represents a number of pulses of the first laser per second, τₚᵢ represents a pulse interval, and τₜₕ represents a thermal relaxation time. It should be noted that, at this time, the OPM is calculated based on the SERF (Spin-Exchange Relaxation-Free) theory.

In some possible embodiments, the first laser is further configured to perform subcutaneous thermal therapy on the measured part. By accumulating laser energy, tissue temperature can be increased by several tens of degrees, thereby enabling thermal therapy induction and temperature feedback imaging in parallel with biomagnetic field detection.

For the apparatus described in Scheme 1 or Scheme 2, in optional embodiments, assuming that the first laser propagates along the Z-axis, the attenuation of the first laser at position z along the Z-axis is calculated by the following fifth equation:

$$\frac{dI}{dz} = - n {σ}_{a b s} \frac{{I}_{o} ( 1 - {sS}_{z} )}{1 + I / {I}_{sat}}$$

wherein, the integral of the fifth equation corresponds to Equation (6) described above. I represents the intensity of the first laser at position z along the Z-axis, and I₀ represents the intensity of the first laser when incident into the atomic vapor cell.

n represents the atomic density in the atomic vapor cell, which can be calculated according to an empirical formula. For example, for K atoms,

$${n}_{K} = \frac{1 {0}^{26.2682 - 4 \; 453 / T}}{T} ,$$

where the unit of temperature is Kelvin (K).

s represents the average photon spin, for alkali metal atoms without optical pumping, any circularly polarized pump light s can be regarded as 1.

S_{z} represents the component of the atomic spin polarization along the z-axis. σ_{abs}(ν) represents the frequency response of the atom in the vicinity of the resonance frequency.

Iₛₐₜ represents the saturation intensity, which is defined as: when the optical intensity I=Iₛₐₜ, the ground state and the excited state each account for 50%. When FID resonance excitation is applied, the excitation of Iₛₐₜ can be simply assumed to occur without decoherence, and therefore Iₛₐₜ can be simplified as:

$${I}_{s a t} = \frac{π hc Γ}{3 {λ}^{3}} \qquad ( 8 )$$

where h denotes the Planck constant, c denotes the speed of light, Γ denotes the linewidth, and λ denotes the wavelength (for example, 795 nm);
where σ_{abs}(σ)=rₑcfᵣₑₛ [symbol] (ν);
rₑ represents the classical electron radius (rₑ=2.82×10⁻¹⁵), and c represents the speed of light (c=3×10⁸).
fᵣₑₛ represents the oscillator strength. For alkali metal atoms, the fᵣₑₛ of the D1 transition is approximately f_{D1}≈⅓, and fᵣₑₛ of the D2 transition is approximately f_{D2}≈⅔.

[symbol] (ν) represents the broadening of the atomic vapor cell. Since pressure broadening is usually much larger than Doppler broadening and natural broadening, typically on the order of 1-100 GHz, the absorption spectrum of alkali metal atoms is therefore described by the following formula:

$$ℒ ( v ) = \frac{{Γ}^{2} / 4}{{( v - {v}_{0} )}^{2} + {( Γ / 2 )}^{2}} .$$

ν represents the actual frequency; ν₀ represents the resonance frequency, Γ represents the full width at half maximum (FWHM). For example, in a system using He as the buffer gas, the pressure broadening of K atoms is Γ≈13.2 GHZ/amg, where amg is the unit of atomic density, and 1 amg is defined as the density of an ideal gas at a pressure of 1 atmosphere and a temperature of 0° C.

For the above fifth equation, when applying the FID theory, the calculation can be simplified by directly integrating over distance and time. When applying the SERF theory, the light intensity may be expressed using the Lambert W function. In addition to the incomplete pumping effect caused by continuous-wave (CW) lasers, due to the long pulse duration and relatively low power (with respect to the vapor cell length), the component of atomic spin polarization along the z-axis varies with the distance on the z-axis following the corresponding intensity I (depending on I). At this stage, the analytical expression of I with respect to the z-axis equation needs to be written as a Bernoulli-type equation and solved using the Lambert W function. Moreover, spin relaxation cannot be neglected under such conditions, and an additional differential equation must be introduced to account for transverse relaxation and other effects, which may result in the absence of a closed-form analytical solution.

In some possible embodiments, the laser generator comprises two laser devices, which are configured to respectively generate a first laser and a second laser. Specifically, the laser generator may include a detection laser device and a pumping laser device, wherein the pumping laser device and the detection laser device serve simultaneously as light sources for the OPM, and the pumping laser also serves as the light source for the PAI. For this embodiment, reference may be made to the description of apparatus 800 shown in FIG. 8.

Referring to FIG. 8, FIG. 8 illustrates yet another structural schematic diagram of a multimodal fusion detection apparatus based on optical pumping and photoacoustic imaging provided in an embodiment of the present application.

The apparatus 800 may include: a first laser device 810, an optical filter 811, a focusing lens 812, a beam aperture 813, a focusing lens 814, a second laser device 815, an optical filter 816, a focusing lens 817, a beam aperture 818, a focusing lens 819, a refractive lens 820, an atomic vapor cell 830, a balanced photodetector 840, a beam splitter 841, a photodetection port 842, a photodetection port 843, a signal amplifier (AMP) 850, an ultrasonic transducer 851, a beam splitter 853, a reference photodetection port 854, a data acquisition device (DAQ) 860, a fiber coupler 870, an optical amplifier 871, and a diffuser 872.

It can be understood that, according to actual detection requirements, the apparatus 800 may further include more or fewer components that are not shown in FIG. 8, and the specific configuration may be flexibly set by those skilled in the art, and is therefore not limited herein.

With respect to the apparatus 800 shown in FIG. 8, the positional relationships and coupling relationships among the respective devices and components may be referred to FIG. 8, and will not be described in detail hereinafter. The following description of this embodiment will be provided in terms of the propagation paths of the laser beams.

For the propagation path of the first laser: the first laser device 810 may generate the first laser, which propagates through the optical filter 811, the focusing lens 812, the beam aperture 813, and the focusing lens 814, and is then directed to the refractive lens 820. The first laser is refracted by the refractive lens 820 and optically aligned with the atomic vapor cell 830. Thereafter, the first laser propagates through the atomic vapor cell 830 and is directed to the fiber coupler 870. After being received by the fiber coupler 870, the first laser is guided to the optical amplifier 871 and the diffuser 872. After being processed by the optical amplifier 871 and the diffuser 872, the first laser is projected onto the target region. At the target region, the first laser may act on the measured part of the subject, and the interaction produces a corresponding photoacoustic signal. The photoacoustic signal can be acquired by the ultrasonic transducer 851, and the acquired signal can then be transmitted to the signal amplifier 850 and the data acquisition device 860.

For the propagation path of the second laser: the second laser device 815 may generate the second laser, which propagates through the optical filter 816, the focusing lens 817, the beam aperture 818, and the focusing lens 819, and is then directed to the beam splitter 853. The beam splitter 853 divides the second laser into two beams, namely laser A and laser B. Laser A is optically aligned with the atomic vapor cell 830, and after propagating through the atomic vapor cell 830, is directed to the beam splitter 841. The beam splitter 841 may further divide laser A into two beams, which are respectively directed to the photodetection port 842 and the photodetection port 843. The photodetection port 842 and the photodetection port 843 are respectively connected to the balanced photodetector 840. According to the OPM principle, parameters of laser A such as intensity, polarization, or frequency, after propagating through the atomic vapor cell 830, will vary due to physiological signal changes of the measured part of the subject. The photodetection port 842 and the photodetection port 843 can acquire signals corresponding to the intensity variation, polarization variation, or frequency variation of laser A, and transmit such signals to the balanced photodetector 840 and the data acquisition device 860. Laser B is optically aligned with the reference photodetection port 854, which can transmit the acquired laser B to the signal amplifier 850 and the data acquisition device 860.

In the above process, the data acquisition device 860 may respectively acquire the signals corresponding to the intensity variation, polarization variation, or frequency variation of laser A after propagating through the atomic vapor cell 830, as well as the photoacoustic signal corresponding to the interaction between the first laser and the measurement site. The data acquisition device 860 may, according to the OPM principle, output the subject's electrophysiological signal based on the acquired intensity variation, polarization variation, or frequency variation of the laser, thereby realizing an optical pumping magnetometer (OPM). The data acquisition device 860 may further, according to the PAI principle, output the subject's blood oxygen signal based on the photoacoustic signal, thereby realizing a photoacoustic sensor.

In some optional embodiments, the first laser device 810 serves as a pumping laser device, and the second laser device 815 serves as a probe laser device. The probe laser device may be configured as a continuous-wave (CW) laser source or a quasi-continuous-wave (QCW) laser source, and may also be implemented as either a short-pulse or long-pulse laser source.

In particular, the wavelength of the pulsed laser generated by the pumping laser device may be set to be identical to, or approximately close to, 795 nm, while the wavelength of the laser generated by the probe laser device may be set to be detuned from 795 nm (for example, at 780 nm).

For the apparatus 800 shown in FIG. 8, the first laser device 810 and the second laser device 815, among other components, can implement the laser generator in the embodiments illustrated in FIGS. 1 and 3. The laser A may correspond to the second laser in the embodiments of FIGS. 1 and 3, and the emission position of laser A at the beam splitter 853 may correspond to the second laser emission port in FIGS. 1 and 3. The emission position of the first laser at the focusing lens 814 may correspond to the first laser emission port in FIGS. 1 and 3. The refractive lens 820 may implement the laser path controller in the embodiments of FIGS. 1 and 3. The photodetection ports 842, 843, together with the balanced photodetector 840, may implement the photodetector in the embodiments of FIGS. 1 and 3. The ultrasonic transducer 851 and the signal amplifier 850 may implement the photoacoustic detector in the embodiments of FIGS. 1 and 3.

The embodiments shown in FIGS. 1 and 3 and the embodiment shown in FIG. 8 may have more or fewer corresponding relationships, which are not described in detail in this embodiment, and the specific correspondence may be configured according to actual requirements.

Based on the embodiment illustrated in FIG. 8 and its correspondence with the embodiments shown in FIGS. 1 and 3, in some optional embodiments, the apparatus shown in FIGS. 1 and 3 may include a first laser device and a second laser device in the laser generator. The first laser device includes a first laser emission port, and the second laser device includes a second laser emission port. The first laser device is configured to generate a first laser, and the second laser device is configured to generate a second laser.

Based on the embodiments illustrated in FIGS. 1, 3, and 8, the present application further provides a multimodal fusion detection apparatus based on optical pumping and photoacoustic imaging, comprising: a laser generator; an atomic vapor cell optically coupled between the laser generator and a target region, the detection path of the atomic vapor cell being configured to point to the target region; and a detection unit including a photoacoustic detector, a photodetector, and a processor, wherein the processor is electrically connected to both the photoacoustic detector and the photodetector.

The term optical coupling refers to an optical coupling mode in which one or more optical elements (for example, lenses, mirrors, beam splitters, optical fibers, or optical waveguides) are employed to guide, align, and deliver the laser beam generated by the laser generator to the atomic vapor cell and/or the target region, thereby establishing the optical path connection and maximizing the efficiency of optical energy transmission. Of course, when device conditions permit, there are multiple possible implementations of the specific coupling manner between the atomic vapor cell located between the laser generator and the target region, and the present application is not limited thereto.

Wherein: a laser generator is configured to generate a first laser in pulsed form, the irradiation path of the first laser being directed to a target region, and the irradiation path of the first laser at least partially overlapping with a detection path of an atomic vapor cell; the laser generator is further configured to generate a second laser, the irradiation path of the second laser being directed to a photodetector after propagating through the atomic vapor cell, and the wavelength of the second laser being different from the atomic excitation wavelength of the atomic vapor cell; a photoacoustic detector is configured to acquire photoacoustic signal data corresponding to the interaction between the first laser and a measured part of a subject when the measured part is associated with the target region; a photodetector is configured to acquire laser variation data corresponding to the second laser after propagating through the atomic vapor cell; and a processor is configured to determine physiological signals of the subject based on the laser variation data and the photoacoustic signal data.

Further optionally, the laser generator comprises a first laser device and a second laser device, the first laser device being configured to generate a first laser, the first laser device being used to drive atoms in the atomic vapor cell into an excited state during an on-phase of a pulse cycle; the second laser device being configured to generate a second laser at least during an off-phase of the pulse cycle of the first laser; wherein an irradiation path of the first laser is configured to propagate through the atomic vapor cell and then be directed to the target region, and the irradiation path of the first laser after propagating through the atomic vapor cell at least partially overlaps with a detection path of the atomic vapor cell.

Regarding the components, units, objects, or modules in this embodiment, detailed descriptions may be found in other embodiments of the present application and are not repeated herein. It should be understood that, in this embodiment, the detection path of the atomic vapor cell is directed to the target region, the irradiation path of the first laser is directed to the target region, and the irradiation path of the first laser at least partially overlaps with the detection path of the atomic vapor cell. In this way, the detection paths of optical pumping (OPM) and photoacoustic imaging (PAI) at least partially overlap, ensuring that electrophysiological signals and blood oxygen signals originate from the same tissue region, thereby avoiding the spacing requirements between sensors in conventional techniques. In other words, the detection path of the atomic vapor cell can be used both for magnetic field detection and for photoacoustic detection, thereby enabling simultaneous acquisition of magnetic field signals and photoacoustic signals at a single detection point. This allows hardware reuse to achieve multimodal fusion detection at the same location and time, while reducing the device size and minimizing crosstalk between multimodal sensors.

According to the embodiments shown in FIGS. 1, 3, and 8, optionally, the first laser satisfies the photoacoustic pressure requirements of PAI and is further configured to excite atoms in the atomic vapor cell, while the second laser satisfies the relaxation requirements of the OPM principle when propagating through the atomic vapor cell.

The first laser satisfies the photoacoustic pressure requirements of PAI, and its wavelength is configured to be close to or consistent with the atomic excitation wavelength of the atomic vapor cell. For example, one or more of the intensity, frequency, or wavelength of the first laser may meet the design requirements of PAI. Specifically, when the first laser is directed toward the target region 140, it is capable of generating a sufficient initial photoacoustic pressure to be detected by the photoacoustic probe. The specific parameter settings may be configured according to actual design requirements and PAI design principles, and are not limited thereto.

The second laser satisfies the relaxation requirements of the OPM principle when propagating through the atomic vapor cell. For example, one or more of the intensity, frequency, or wavelength of the second laser may meet the relaxation parameter design requirements of OPM. Specifically, within a single pulse, one complete relaxation process can be achieved to effectively provide pumping energy for the OPM. The specific parameter settings may be configured according to actual design requirements and OPM design principles, and are not limited thereto.

According to the above-mentioned multiple device embodiments, in some optional embodiments, the laser path controller may include a refractor, or the laser path controller may include a refractor and a collimating lens. In some optional embodiments, the laser path controller may further include an optical filter or a polarizer, thereby enabling control of the laser path.

According to the above-mentioned multiple device embodiments, in some optional embodiments, the apparatus further includes an optical fiber guiding module, wherein the laser emitted from the path control emission port is directed toward the target region via the optical fiber guiding module. The optical fiber guiding module may include a fiber coupler, an amplifier, and a diffuser, for example, the fiber coupler 270, amplifier 271, and diffuser 272 as shown in FIG. 2.

According to the above-mentioned multiple device embodiments, in some optional embodiments, the second laser satisfies the relaxation requirements of the optical pumping magnetometer principle when propagating through the atomic vapor cell, and the first laser satisfies the photoacoustic pressure requirements of photoacoustic imaging.

The second laser satisfies the relaxation requirements of the OPM-MEG principle when propagating through the atomic vapor cell. For example, one or more of the intensity, frequency, or wavelength of the second laser may be configured to meet the relaxation parameter design requirements of OPM-MEG. Specifically, within a single pulse, a complete relaxation process can be achieved to effectively provide pumping energy for OPM. The specific parameter settings may be configured according to actual design requirements and the design principles of OPM-MEG, and are not limited thereto.

The first laser satisfies the photoacoustic pressure requirements of PAI. For example, one or more of the intensity, frequency, or wavelength of the first laser may be configured to meet the design requirements of PAI. Specifically, when the laser emitted from the path control emission port is directed toward the target region through the optical fiber guiding module, it can generate a sufficient initial photoacoustic pressure detectable by the ultrasonic probe. The specific parameter settings may be configured according to actual design requirements and the design principles of PAI, and are not limited thereto.

The present application further provides a magnetometer, which is configured to operate in a non-magnetic-shielding environment.

In particular, the magnetometer is configured to perform the following steps 1.1 to 1.3 during measurement:

Step 1.1: Each sensor unit of the magnetometer measures in real time the instantaneous magnetic field value at its location and transmits the instantaneous magnetic field value to a controller of the magnetometer.

Step 1.2: The controller calculates three compensation currents corresponding to the X, Y, and Z axes.

Step 1.3: The controller controls a three-axis compensation coil of the magnetometer according to the three compensation currents so as to generate a compensation magnetic field, wherein the compensation magnetic field is opposite in direction to the external magnetic field.

Steps 1.1 to 1.3 represent a zero-order active compensation for rapidly suppressing common-mode magnetic field interference (also referred to as coarse-loop compensation).

Specifically, the magnetometer transmits the instantaneous magnetic field values of the respective sensor units to a digital controller. The controller outputs three compensation currents with a bandwidth of 100-300 Hz, which are loaded via a DAC into a three-axis compensation coil coaxial with all sensor units, thereby generating a constant compensation magnetic field in the opposite direction. As a result, the absolute value of the residual magnetic field at each unit is maintained within 10 nT (empirical value).

During this process, the values of the three compensation currents can be synchronously recorded and used as the zero-order common-field compensation quantity B₀(t).

In an optional embodiment, the above-described magnetometer is further configured, during measurement, to perform the following Steps 1.4-1.6:

Step 1.4: The controller periodically acquires the residual magnetic field vectors of the acquisition channels corresponding to the respective sensor units.

Step 1.5: The controller determines the first-order spatial gradient of the compensation magnetic field based on the residual magnetic field vectors and the three compensation currents.

Step 1.6: The controller drives the three-axis compensation coils according to the first-order spatial gradient to generate a gradient compensation field in the opposite direction of the first-order spatial gradient.

Steps 1.4-1.6 represent a periodic decomposition and suppression of the spatial gradient to ensure high-precision measurement in a non-magnetically shielded environment (also referred to as fine-loop compensation).

Specifically, for example, with a cycle of 5 ms, the magnetometer acquires the residual magnetic field vectors b=[b₁ . . . bₙ]^{T} of each channel together with the geometric coordinate matrix G, and solves in real time using the least-squares method:

$$b = {G [ {B}_{0} , {G}_{x} , {G}_{y} , {G}_{z} ]}^{T}$$

Here, b denotes an n×1 column vector representing the residual magnetic field components measured by the n channels of the magnetometer array (for example, the magnetic field projection value at the location of each magnetometer). These values are acquired at a given moment (e.g., with a cycle of 5 ms). B₀ denotes a global bias magnetic field component or constant term, representing part of the uniform background magnetic field intensity sensed by all sensors (for example, a uniform DC field or system bias). Gₓ, G_{y} and G_{z} denote the linear gradient components of the magnetic field in the spatial x, y, and z directions, respectively, which can also be understood as the rates of change of the magnetic field with respect to the x, y, and z spatial coordinates. The units are T/m or nT/cm. Together, they describe a first-order magnetic field model in which the magnetic field value at each position is obtained by superimposing the constant term and the linear variation at that position.

The obtained zero-order common field B₀(t) can be directly subtracted from the data of all channels. The obtained first-order spatial gradient (Gₓ, G_{y}, G_{z}) is converted into control quantities through proportional coefficients and injected in real time into the tri-axial compensation coils of each independent channel, thereby generating a gradient compensation field oriented opposite to the gradient direction, so as to ensure high-precision measurement in a non-magnetically shielded environment.

For the above steps 1.1-1.6, the process begins with coarse-loop compensation, which rapidly reduces common magnetic field interference, and then proceeds to fine-loop compensation, which periodically decomposes and suppresses spatial gradients. The entire loop operates at a high frequency (coarse loop: 100-300 Hz; fine loop: 5 ms cycle), thereby ensuring high-precision measurement in a non-magnetically shielded environment.

In an optional embodiment, two total-field magnetometers are employed to directly measure the Larmor precession frequency of alkali vapor electron spins in a magnetic field. Compared with voltage measurements associated with other magnetic sensors, frequency measurement provides a larger dynamic range and higher linearity. Moreover, no separate calibration is required; therefore, the first-order magnetic field gradient can be obtained simply by subtracting the recorded frequencies from the two alkali vapor cells. It can be understood that a first-order gradiometer can perform the detection of biomagnetic signals even in more complex environments.

In an optional embodiment, the present application further provides an ultrasonic probe that operates in an air-coupled manner, the probe being capable of operating without coupling agents and without electromagnetic shielding of the biosensor. The detection approach may include not only conventional piezoelectric ceramics but also fiber-optic ultrasonic transducer schemes.

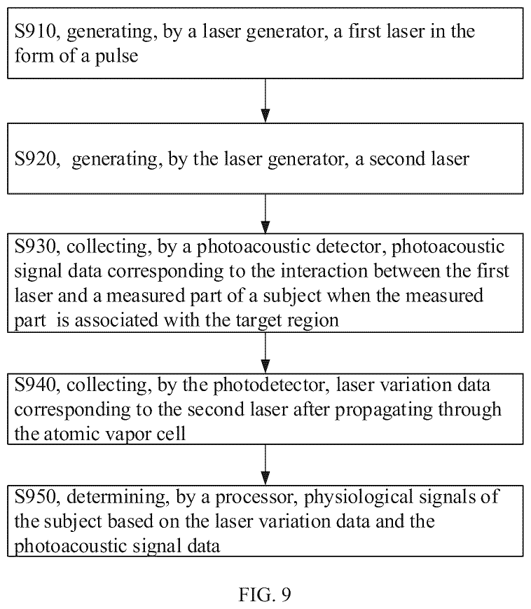

Referring to FIG. 9, FIG. 9 illustrates a flowchart of a multimodal fusion detection method based on optical pumping and photoacoustic imaging according to an embodiment of the present application, which can be applied to the apparatus embodiments described above. The method includes the following steps:
S910, generating, by a laser generator, a first laser in the form of a pulse, wherein an irradiation path of the first laser is directed to a target region, and the irradiation path of the first laser at least partially overlaps with a detection path of an atomic vapor cell;
S920, generating, by the laser generator, a second laser, wherein an irradiation path of the second laser propagates through the atomic vapor cell and is directed to a photodetector, and a wavelength of the second laser is different from an atomic excitation wavelength of the atomic vapor cell;
S930, collecting, by a photoacoustic detector, photoacoustic signal data corresponding to the interaction between the first laser and a measured part of a subject when the measured part is associated with the target region;
S940, collecting, by the photodetector, laser variation data corresponding to the second laser after propagating through the atomic vapor cell;
S950, determining, by a processor, physiological signals of the subject based on the laser variation data and the photoacoustic signal data.

It should be understood that the specific implementations and descriptions of the method embodiment illustrated in FIG. 9 may refer to the relevant parts of the embodiments illustrated in FIGS. 1, 3, and 8, and are therefore not repeated herein.

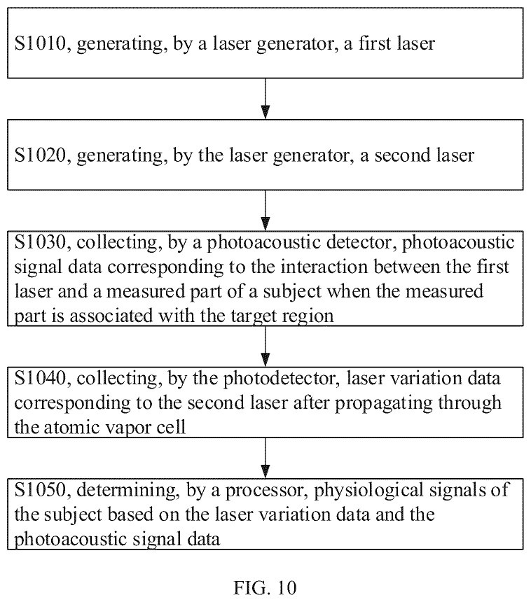

Referring to FIG. 10, FIG. 10 illustrates another flowchart of a multimodal fusion detection method based on optical pumping and photoacoustic imaging according to an embodiment of the present application, which can be applied to the apparatus embodiments described above. The method includes the following steps:
S1010, generating, by a laser generator, a first laser, wherein the first laser is configured as a continuous-wave (CW) laser or a quasi-continuous-wave (QCW) laser, an irradiation path of the first laser propagates through an atomic vapor cell and is directed to a target region, and the first laser is used to drive atoms in the atomic vapor cell into an excited state;
S1020, generating, by the laser generator, a second laser, wherein an irradiation path of the second laser propagates through the atomic vapor cell and is directed to a photodetector, and a wavelength of the second laser is different from an atomic excitation wavelength of the atomic vapor cell;
S1030, collecting, by a photoacoustic detector, photoacoustic signal data corresponding to the interaction between the first laser and a measured part of a subject when the measured part is associated with the target region;
S1040, collecting, by the photodetector, laser variation data corresponding to the second laser after propagating through the atomic vapor cell;
S1050, determining, by a processor, physiological signals of the subject based on the laser variation data and the photoacoustic signal data.

It should be understood that the specific implementations and descriptions of the method embodiment illustrated in FIG. 10 may refer to the relevant parts of the embodiments illustrated in FIGS. 1, 3, and 8, and are therefore not repeated herein.

The foregoing descriptions are merely exemplary embodiments of the present application and are not intended to limit the scope of protection thereof. For those skilled in the art, the present application may be subject to various modifications and variations. Any modifications, equivalent replacements, or improvements made within the spirit and principles of the present application shall fall within the scope of protection of the present application.

What is claimed is:

1. A multimodal fusion detection apparatus based on optical pumping and photoacoustic imaging, comprising:
a laser generator;
an atomic vapor cell optically coupled between the laser generator and a target region, the atomic vapor cell having a detection path configured to be directed toward the target region;
a detection unit comprising a photoacoustic detector, a photodetector, and a processor, the processor being electrically connected to both the photoacoustic detector and the photodetector;
wherein the laser generator is configured to generate a first laser in pulsed form, an irradiation path of the first laser being directed toward the target region, the irradiation path of the first laser at least partially overlapping with the detection path of the atomic vapor cell;
the laser generator is further configured to generate a second laser, an irradiation path of the second laser propagating through the atomic vapor cell and being directed toward the photodetector, the wavelength of the second laser being different from an atomic excitation wavelength of the atomic vapor cell;
the photoacoustic detector is configured to, when a measured part of a subject is associated with the target region, acquire photoacoustic signal data corresponding to an interaction between the first laser and the measured part;
the photodetector is configured to acquire laser variation data corresponding to the second laser after propagating through the atomic vapor cell;
and the processor is configured to determine physiological signals of the subject based on the laser variation data and the photoacoustic signal data.

2. The apparatus according to claim 1, wherein the laser generator comprises a first laser device and a second laser device,
the first laser device is configured to generate the first laser, the first laser being used to excite atoms in the atomic vapor cell into an excited state during an on-phase of a pulse cycle;
the second laser device is configured to generate the second laser at least during an off-phase of the pulse cycle of the first laser;
wherein an irradiation path of the first laser is configured to propagate through the atomic vapor cell and then be directed toward the target region, the irradiation path of the first laser after propagating through the atomic vapor cell at least partially overlapping with the detection path of the atomic vapor cell.

3. The apparatus according to claim 2, wherein determining physiological signals of the subject based on the laser variation data and the photoacoustic signal data comprises:
determining an electromagnetic physiological signal of the subject based on the laser variation data, wherein the laser variation data comprises one or more of: a frequency, intensity, polarization signal, or zero-crossing point of the second laser after propagating through the atomic vapor cell;
and determining a blood oxygen signal of the subject based on the photoacoustic signal data.

4. The apparatus according to claim 3, wherein a pulse width of the first laser is selected from any one of the following ranges: a first range, a second range, and a third range, wherein
the first range is configured such that a stress relaxation time<the pulse width<a first empirical value, and the first empirical value<a thermal relaxation time;
the second range is configured such that the first empirical value<the pulse width<a second empirical value, and the second empirical value<the thermal relaxation time;
and the third range is configured such that the pulse width≥the thermal relaxation time.

5. The apparatus according to claim 4, wherein a maximum value and a minimum value of the first range are determined based on a first characteristic exhibited by the first laser, the first characteristic comprising that, a photoacoustic pressure signal, corresponding to the interaction of the first laser with the measured part of the subject, presents a positive-negative pulse form;
a maximum value and a minimum value of the second range are determined based on a second characteristic exhibited by the first laser, the second characteristic comprising that, a photoacoustic pressure signal, corresponding to the interaction of the first laser with the measured part of the subject and conducted by a photoacoustic signal, has a negative photoacoustic pulse amplitude greater than a positive photoacoustic pulse amplitude;
and a maximum value and a minimum value of the third range are determined based on a third characteristic exhibited by the first laser, the third characteristic comprising that, a photoacoustic pressure signal, corresponding to the interaction of the first laser with the measured part of the subject and conducted by a photoacoustic signal, presents a trend in which the amplitude of the negative photoacoustic pulse first increases and then decreases.

6. The apparatus according to claim 4, wherein when the pulse width of the first laser is selected within the first range, determining a blood oxygen signal of the subject based on the photoacoustic signal data comprises:
determining the blood oxygen signal of the subject according to a first equation as follow:
$${p}_{1} = {Γ}_{0} {η}_{t h} {μ}_{a} ϕ δ t$$
wherein p₁ represents a photoacoustic signal, Γ₀ represents a Grüneisen coefficient at ambient temperature, ηₜₕ represents a conversion efficiency from heat to acoustic energy, μₐ represents an optical absorption coefficient, φ represents an optical irradiation intensity,
and δt represents an optical irradiation time.

7. The apparatus according to claim 4, wherein when the pulse width of the first laser is selected within the second range, determining a blood oxygen signal of the subject based on the photoacoustic signal data comprises:
determining the blood oxygen signal of the subject according to a second equation as follow:
$${p}_{2} = {p}_{1} + b {η}_{t h}^{2} {μ}_{a}^{2} {ϕ}^{2} δ t {τ}_{t h}^{2} [ 1 - ( 1 + \frac{Δ t}{{τ}_{t h}} ) {e}^{- \frac{Δ t}{{τ}_{t h}}} ]$$
wherein p₂ represents a photoacoustic signal, p₁=Γ₀ηₜₕμₐφδt, Γ₀ represents a Grüneisen coefficient at ambient temperature, ηₜₕ represents a conversion efficiency from heat to acoustic energy, μₐ represents an optical absorption coefficient, φ represents an optical irradiation intensity, δt represents an optical irradiation time, b represents a proportionality coefficient relating absorbed thermal energy to variations of the Grüneisen parameter, Δt represents a pulse width of laser, and τₜₕ represents a thermal relaxation time.

8. The apparatus according to claim 4, wherein when the pulse width of the first laser is selected within the third range, determining a blood oxygen signal of the subject based on the photoacoustic signal data comprises:
determining the blood oxygen signal of the subject according to a third equation as follow:
$${p}_{2} = {Γ}_{0} {η}_{t h} {μ}_{a} ϕ \cdot Δ t \cdot {e}^{- \frac{Δ t}{{τ}_{t h}}}$$
wherein p₂ represents a photoacoustic signal, Γ₀ represents a Grüneisen coefficient at ambient temperature, ηₜₕ represents a conversion efficiency from heat to acoustic energy, μₐ represents an optical absorption coefficient, φ represents an optical irradiation intensity, Δt represents a pulse width of laser, and τₜₕ represents a thermal relaxation time.

9. The apparatus according to claim 4, wherein when the pulse width of the first laser is selected within the first range, the pulse width of the first laser is determined based on a first optical pumping reference pulse width;
when the pulse width of the first laser is selected within the second range, the pulse width of the first laser is determined based on a second optical pumping reference pulse width;
and when the pulse width of the first laser is selected within the third range, an optimal pulse width of the first laser is determined based on the thermal relaxation time.

10. The apparatus according to claim 3, wherein the atomic vapor cell comprises a polarization coil;
the polarization coil is configured to apply a modulated magnetic field to the atomic vapor cell according to preset modulation parameters;
wherein determining the electromagnetic physiological signal of the subject based on the laser variation data comprises:
determining, based on the preset modulation parameters and the laser variation data, one or more of the following for the subject: a vector-dimensional electromagnetic physiological signal, and a magnetic field modulation signal.

11. The apparatus according to claim 10, wherein an alternating current heater of the atomic vapor cell is turned on during an on-phase of the pulse cycle, and the alternating current heater of the atomic vapor cell is turned off during an off-phase of the pulse cycle.

12. The apparatus according to claim 2, wherein the apparatus is configured to operate in a non-magnetic shielding environment or within magnetic compensation coils.

13. The apparatus according to claim 4, wherein when the pulse width of the first laser is selected within the third range, the first laser is further configured to perform subcutaneous thermal therapy on the measured part of the subject.

14. The apparatus according to claim 2, wherein the first laser propagates along a Z-axis, and an attenuation of the first laser at a position z on the Z-axis is calculated according to the following equation:
$$\frac{dI}{d z} = - n {σ}_{a b s} \frac{{I}_{0} ( 1 - s {S}_{z} )}{1 + I / {I}_{s a t}}$$
wherein I represents an optical intensity of the first laser at the position z on the Z-axis, I₀ represents an incident optical intensity of the first laser when entering the atomic vapor cell, n represents an atomic density in the atomic vapor cell, n represents an atomic density in the atomic vapor cell, s represents an average photon spin, S_{z} represents a component of atomic spin polarization along the Z-axis, σ_{abs}(ν) represents a frequency response of atoms near a resonance frequency, Iₛₐₜ represents a saturation intensity,
wherein σ_{abs}(ν)=rₑcfᵣₑₛL(ν), rₑ represents a classical electron radius, c represents a speed of light, fᵣₑₛ represents a resonance strength, L(ν) represents a broadening of the atomic vapor cell,
$$L ( v - {v}_{0} ) = \frac{{Γ}^{2} / 2 π}{{( v - {v}_{0} )}^{2} + {( Γ / 2 )}^{2}} ,$$
ν represents an actual frequency, ν₀ represents a resonance frequency, Γ represents a full width at half maximum.

15. The apparatus according to claim 1, wherein the laser generator comprises a third laser device and a beam splitter;
wherein the third laser device is configured to generate a third laser, and the beam splitter is configured to split the third laser into the first laser and the second the laser.

16. A multimodal fusion detection apparatus based on optical pumping and photoacoustic imaging, wherein the apparatus is configured to operate in a magnetic shielding environment, the apparatus comprising:
a laser generator;
an atomic vapor cell optically coupled between the laser generator and a target region, the atomic vapor cell having a detection path configured to be directed toward the target region;
a detection unit comprising a photoacoustic detector, a photodetector, and a processor, the processor being electrically connected to both the photoacoustic detector and the photodetector;
wherein the laser generator is configured to generate a first laser, the first laser being a continuous-wave laser or a quasi-continuous-wave laser, an irradiation path of the first laser propagating through the atomic vapor cell and being directed toward the target region, the first laser being used to excite atoms in the atomic vapor cell into an excited state;
the laser generator is further configured to generate a second laser, an irradiation path of the second laser propagating through the atomic vapor cell and being directed toward the photodetector, the wavelength of the second laser being different from an atomic excitation wavelength of the atomic vapor cell;
the photoacoustic detector is configured to, when a measured part of a subject is associated with the target region, acquire photoacoustic signal data corresponding to an interaction between the first laser and the measured part;
the photodetector is configured to acquire laser variation data corresponding to the second laser after propagating through the atomic vapor cell;
and the processor is configured to determine physiological signals of the subject based on the laser variation data and the photoacoustic signal data.

17. The apparatus according to claim 16, wherein determining the physiological signals of the subject based on the laser variation data and the photoacoustic signal data comprises:
determining an electromagnetic physiological signal of the subject based on the laser variation data,
wherein the laser variation data comprises an intensity variation signal and a polarization variation signal of the second laser after propagating through the atomic vapor cell;
and determining a blood oxygen signal of the subject based on the photoacoustic signal data.

18. The apparatus according to claim 17, wherein determining a blood oxygen signal of the subject based on the photoacoustic signal data comprises:
determining the blood oxygen signal of the subject according to a fourth equation as follow:
$${p}_{qCW 1 , 2} = {p}_{1 , 2} + B {τ}_{t h}^{2} \{ 1 [ 1 + \frac{( n - 1 ) ( {τ}_{t {h}^{-}} {τ}_{p i} )}{{τ}_{t h}} ] {e}^{- \frac{( n - 1 ) ( {τ}_{in} - {τ}_{pi} )}{{τ}_{t h}}} \} , {τ}_{t {h}^{-}} {τ}_{p i} > 0$$
wherein P_{qCW1,2} represents the photoacoustic signal, p_{1,2} represents a difference between a leading edge and a trailing edge of the photoacoustic signal, B represents
$$b {η}_{t h}^{2} {μ}_{a}^{2} {φ}^{2} δ t ,$$
b represents a proportionality coefficient relating absorbed thermal energy to variations of the Grüneisen parameter, ηₜₕ represents a conversion efficiency from heat to acoustic energy, μₐ represents an optical absorption coefficient, φ represents an optical irradiation intensity, δt represents an optical irradiation time, n represents a number of pulses of the first laser per second, τₚᵢ represents a pulse interval, and τₜₕ represents a thermal relaxation time.

19. The apparatus according to claim 16, wherein the first laser is further configured to perform subcutaneous thermal therapy on the measured part of the subject.

20. A multimodal fusion detection method based on optical pumping and photoacoustic imaging, applied to a multimodal fusion detection apparatus, the apparatus comprising a laser generator, an atomic vapor cell, and a detection unit,
wherein the atomic vapor cell is optically coupled between the laser generator and a target region, the atomic vapor cell having a detection path configured to be directed toward the target region;
the detection unit comprises a photoacoustic detector, a photodetector, and a processor, the processor being electrically connected to both the photoacoustic detector and the photodetector;
the method comprising:
generating, by the laser generator, a first laser in pulsed form, an irradiation path of the first laser being directed toward the target region, the irradiation path of the first laser at least partially overlapping with the detection path of the atomic vapor cell;
generating, by the laser generator, a second laser, an irradiation path of the second laser propagating through the atomic vapor cell and being directed toward the photodetector, the wavelength of the second laser being different from an atomic excitation wavelength of the atomic vapor cell;
acquiring, by the photoacoustic detector, photoacoustic signal data corresponding to an interaction between the first laser and a measured part of a subject when the measured part is associated with the target region;
acquiring, by the photodetector, laser variation data corresponding to the second laser after propagating through the atomic vapor cell;
and determining, by the processor, physiological signals of the subject based on the laser variation data and the photoacoustic signal data.
